(19) United States
(12) Patent Application Publication
(10) Pub. No.: US 2026/0339307 A1
(43) Pub. Date: Oct. 29, 2026

(54) UNMANNED INTELLIGENT MANUFACTURING SYSTEM

(71) Applicants: GUANGZHOU DOUBLE WIN AUTOMOBILE EQUIPMENT GROUP CO., LTD., Guangzhou (CN); JINAN DOUBLE WIN AUTOMOBILE EQUIPMENT ENGINEERING CO., LTD., Jinan (CN); JINAN DOUBLE WIN AUTOMATION EQUIPMENT ENGINEERING CO., LTD., Jinan (CN); GUANGZHOU DOUBLE WIN MECHANICAL ELECTRICAL EQUIPMENT CO., LTD., Guangzhou (CN); GUANGZHOU DOUBLE WIN AUTO PARTS CO., LTD., Guangzhou (CN)

(72) Inventors: Chi ZHANG, Guangzhou (CN); Sanyi ZHANG, Jinan (CN); Haibo CUI, Jinan (CN); Risheng ZHOU, Jinan (CN); Jinqing YUAN, Guangzhou (CN); Rendong MA, Jinan (CN)

(73) Assignees: GUANGZHOU DOUBLE WIN AUTOMOBILE EQUIPMENT GROUP CO., LTD., Guangzhou (CN); JINAN DOUBLE WIN AUTOMOBILE EQUIPMENT ENGINEERING CO., LTD., Jinan (CN); JINAN DOUBLE WIN AUTOMATION EQUIPMENT ENGINEERING CO., LTD., Jinan (CN); GUANGZHOU DOUBLE WIN MECHANICAL ELECTRICAL EQUIPMENT CO., LTD., Guangzhou (CN); GUANGZHOU DOUBLE WIN AUTO PARTS CO., LTD., Guangzhou (CN)

(21) Appl. No.: 19/732,552

(22) Filed: Jul. 6, 2026

Related U.S. Application Data
(63) Continuation-in-part of application No. 18/692,221, filed on Mar. 24, 2023.

(30) Foreign Application Priority Data
Apr. 9, 2022 (CN) 202210368662.9

(51) Int. Cl. G05B 19/418; G06Q 10/0639; G06Q 10/087; G06Q 10/0875; G06Q 50/04

(52) U.S. Cl. CPC G05B 19/41875; G05B 19/41865; G05B 19/41895; G06Q 10/06395; G06Q 10/08726; G06Q 10/0875; G06Q 50/04

(57) ABSTRACT

Provided is an unmanned intelligent manufacturing system, comprising: an intelligent manufacturing platform, an enterprise resource planning (ERP) platform, and an unmanned stamping platform. An input end of the intelligent manufacturing platform is electrically connected to the ERP platform, and an output end of the intelligent manufacturing platform is electrically connected to the unmanned stamping platform. The intelligent manufacturing platform comprises a material data module, a first material inventory module, a bill-of-materials (BOM) module, a production scheduling module, and a device information module. The ERP platform comprises a production order module, a warehouse data module, a second material inventory module, a bill of materials, and an automatic scheduling module. The unmanned stamping platform comprises an uncoiling blanking line, a stamping line, an automatic quality inspection module, an automatic packaging module, an automated storage and retrieval module, and an automated guided vehicle (AGV) module.

### CROSS-REFERENCE TO RELATED APPLICATIONS

This application is a continuation-in-part of U.S. patent application Ser. No. 18/692,221, filed on Mar. 14, 2024, which is the U.S. National Stage of International Application No. PCT/CN2023/083828, filed on Mar. 24, 2023, which claims priority to Chinese Patent Application No. 202210368662.9, filed on Apr. 9, 2022. The entire disclosures of the above applications are incorporated herein by reference.

### TECHNICAL FIELD

The present disclosure relates to the technical field of automotive-manufacturing stamping plants, and more particularly to an unmanned intelligent manufacturing system.

### BACKGROUND

Conventional automotive-manufacturing stamping plants are planned manually by personnel during operation and require a large number of operators to operate machinery. As a result, automated production cannot be achieved, causing users to rely heavily on manual labor, thereby increasing labor intensity and wasting substantial amounts of time.

Accordingly, there is an urgent need for an unmanned intelligent manufacturing system capable of realizing unmanned automatic production in a stamping plant while reducing labor intensity and time costs associated with manual operations.

### SUMMARY

To address the problems existing in the background art described above, an objective of the present disclosure is to provide an unmanned intelligent manufacturing system having the advantage of enabling automated production, thereby solving the problem that automated production cannot be achieved.

The unmanned intelligent manufacturing system comprises an intelligent manufacturing platform, an enterprise resource planning (ERP) platform, and an unmanned stamping platform. An input end of the intelligent manufacturing platform is electrically connected to the ERP platform, and an output end of the intelligent manufacturing platform is electrically connected to the unmanned stamping platform. The intelligent manufacturing platform comprises a material data module, a first material inventory module, a bill-of-materials (BOM) module, a production scheduling module, and a device information module. The ERP platform comprises a production order module, a warehouse data module, a second material inventory module, a bill of materials, and an automatic scheduling module, wherein an output end of the production order module is electrically connected to an input end of the material data module, an output end of the warehouse data module is electrically connected to an input end of the first material inventory module, an output end of the second material inventory module is electrically connected to the input end of the first material inventory module, an output end of the bill of materials is electrically connected to an input end of the BOM module, and an output end of the automatic scheduling module is electrically connected to an input end of the production scheduling module. The unmanned stamping platform comprises an uncoiling blanking line, a stamping line, an automatic quality inspection module, an automatic packaging module, an automated storage and retrieval module, and an automated guided vehicle (AGV) module, wherein an output end of the device information module is electrically connected to an input end of the uncoiling blanking line, the output end of the device information module is electrically connected to an input end of the stamping line, the output end of the device information module is electrically connected to an input end of the automatic quality inspection module, the output end of the device information module is electrically connected to an input end of the automatic packaging module, the output end of the device information module is electrically connected to an input end of the automated storage and retrieval module, the output end of the device information module is electrically connected to an input end of the AGV module, an output end of the production scheduling module is electrically connected to the input end of the uncoiling blanking line, the output end of the production scheduling module is electrically connected to the input end of the stamping line, an output end of the material data module is electrically connected to the input end of the uncoiling blanking line, the output end of the material data module is electrically connected to the input end of the stamping line, an output end of the BOM module is electrically connected to the input end of the uncoiling blanking line, and the output end of the BOM module is electrically connected to the input end of the stamping line. The intelligent manufacturing platform further comprises an eccentricity detection array configured to: acquire a weight distribution matrix of stacked blanks; and determine a center-of-gravity offset vector of the stacked blanks based on the weight distribution matrix. The production scheduling module is configured to: generate motion control parameters based on the center-of-gravity offset vector and transmit the motion control parameters to the AGV module, the motion control parameters comprising a centripetal-force threshold curve and acceleration step limits. The AGV module is configured to: under a turning condition, determine a target centripetal-force threshold from the centripetal-force threshold curve based on current operating parameters of an automated transport unit, and limit an angular velocity of a steering motor of the automated transport unit based on the target centripetal-force threshold; and under a braking condition, reduce output torque of drive wheels of the automated transport unit in stages based on the acceleration step limits or increase braking force applied to the drive wheels in stages.

### BRIEF DESCRIPTION OF THE DRAWINGS

The present disclosure will be further elucidated by way of exemplary embodiments, which are described in detail with reference to the accompanying drawings. These embodiments are not limiting. In these embodiments, the same reference numerals denote the same structures, wherein:

FIG. 1 is a schematic diagram of an unmanned intelligent manufacturing system according to some embodiments of the present disclosure.

FIG. 2 is a system diagram illustrating interfacing between an intelligent manufacturing platform and an enterprise resource planning (ERP) platform according to some embodiments of the present disclosure.

FIG. 3 is a system diagram illustrating interfacing between an intelligent manufacturing platform and an unmanned stamping platform according to some embodiments of the present disclosure.

FIGS. 4a and 4b show a workflow system diagram of an intelligent manufacturing platform according to some embodiments of the present disclosure.

FIG. 5 is an architectural system diagram of an intelligent manufacturing platform according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose. The term “and/or”, as used herein, is merely a way of describing the associative relationship of an associated object, indicating that three relationships may exist, e.g., A and/or B, which may be represented as: A alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

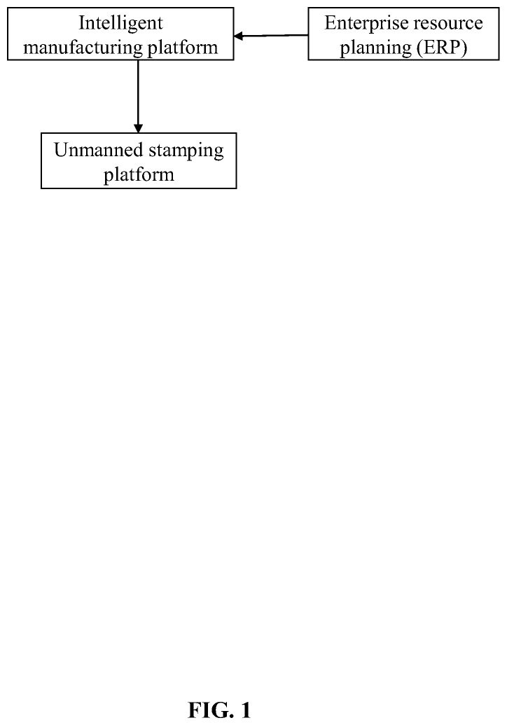

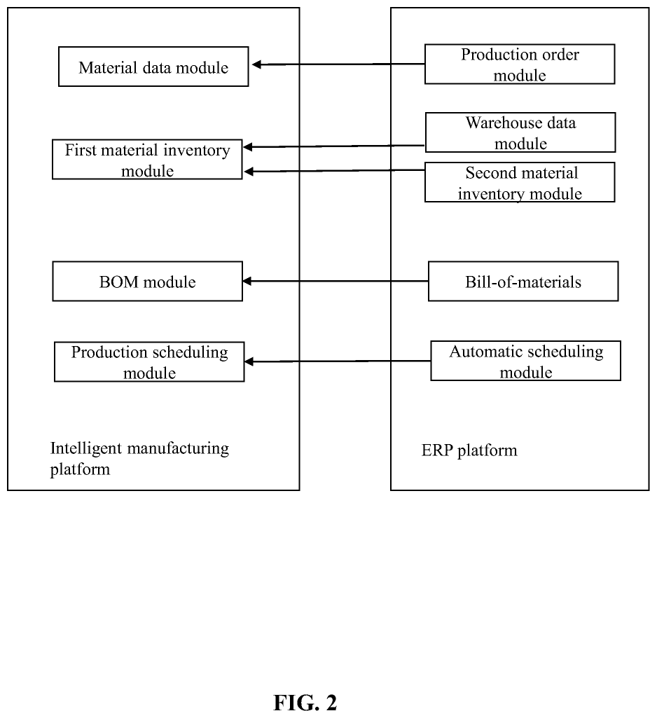

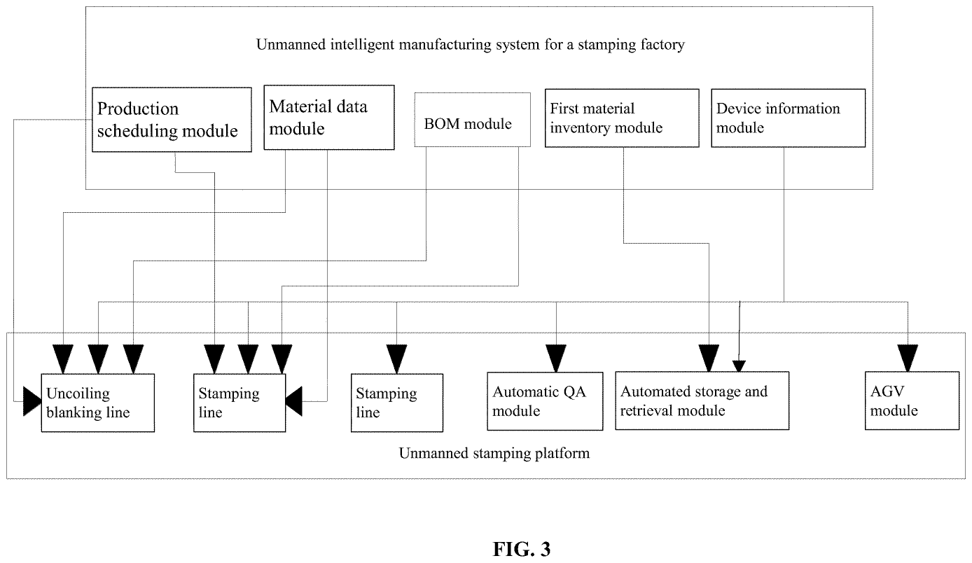

FIG. 1 is a schematic diagram of an unmanned intelligent manufacturing system according to some embodiments of the present disclosure. FIG. 2 is a system diagram illustrating interfacing between an intelligent manufacturing platform and an enterprise resource planning (ERP) platform according to some embodiments of the present disclosure. FIG. 3 is a system diagram illustrating interfacing between an intelligent manufacturing platform and an unmanned stamping platform according to some embodiments of the present disclosure.

In some embodiments, as shown in FIGS. 1-3, the unmanned intelligent manufacturing system comprises an intelligent manufacturing platform, an ERP platform, and an unmanned stamping platform, wherein an input end of the intelligent manufacturing platform is electrically connected to the ERP platform, and an output end of the intelligent manufacturing platform is electrically connected to the unmanned stamping platform. The intelligent manufacturing platform comprises a material data module, a first material inventory module, a bill-of-materials (BOM) module, a production scheduling module, and a device information module.

In some embodiments, as shown in FIG. 2, the ERP platform comprises a production order module, a warehouse data module, a second material inventory module, a bill of materials, and an automatic scheduling module, wherein an output end of the production order module is electrically connected to an input end of the material data module, an output end of the warehouse data module is electrically connected to an input end of the first material inventory module, an output end of the second material inventory module is electrically connected to the input end of the first material inventory module, an output end of the bill of materials is electrically connected to an input end of the BOM module, and an output end of the automatic scheduling module is electrically connected to an input end of the production scheduling module.

In some embodiments, as shown in FIG. 3, the unmanned stamping platform comprises an uncoiling blanking line, a stamping line, an automatic quality inspection module, an automatic packaging module, an automated storage and retrieval module, and an automated guided vehicle (AGV) module, wherein an output end of the device information module is electrically connected to an input end of the uncoiling blanking line, the output end of the device information module is electrically connected to an input end of the stamping line, the output end of the device information module is electrically connected to an input end of the automatic quality inspection module, the output end of the device information module is electrically connected to an input end of the automatic packaging module, the output end of the device information module is electrically connected to an input end of the automated storage and retrieval module, the output end of the device information module is electrically connected to an input end of the AGV module, an output end of the production scheduling module is electrically connected to the input end of the uncoiling blanking line, the output end of the production scheduling module is electrically connected to the input end of the stamping line, an output end of the material data module is electrically connected to the input end of the uncoiling blanking line, the output end of the material data module is electrically connected to the input end of the stamping line, an output end of the BOM module is electrically connected to the input end of the uncoiling blanking line, the output end of the BOM module is electrically connected to the input end of the stamping line, and an output end of the first material inventory module is electrically connected to the input end of the automated storage and retrieval module.

In some embodiments, the intelligent manufacturing platform, the enterprise resource planning (ERP) platform, and the unmanned stamping platform are capable of communicating with one another. In addition, different modules and units within each platform are also capable of communicating with one another.

The intelligent manufacturing platform (also referred to as a stamping factory unmanned intelligent manufacturing system) refers to an information-based platform configured to receive production orders, material information, production scheduling plans, or the like issued by the ERP platform, and to schedule and manage production devices and manufacturing resources.

The material data module refers to a functional module configured to receive, store, and manage material information corresponding to production orders.

The material information refers to a collection of data used to describe attributes associated with raw materials, semi-finished products, or finished products to be processed, and is used to characterize categories, specifications, and production requirements of materials and provide data support for uncoiling and blanking operations, stamping operations, and production scheduling. For example, the material information may comprise a material identification number, a material name, a specification and model designation, process parameters, delivery requirements, or the like.

In some embodiments, the material data module receives production orders from the production order module and drives the uncoiling blanking line and the stamping line to operate based on the production orders.

The first material inventory module refers to an inventory management module provided in the intelligent manufacturing platform.

The BOM module (also referred to as a material BOM module) refers to a functional module configured to manage material composition relationships required during a product manufacturing process.

In some embodiments, the BOM module may receive a bill of materials from the ERP platform and establish corresponding relationships among products, raw materials, and components, thereby providing a basis for material allocation for the uncoiling blanking line and the stamping line.

The production scheduling module (also referred to as a scheduling planning module) refers to a module provided in the intelligent manufacturing platform for generating and executing production plans.

In some embodiments, the production scheduling module may be configured to receive a scheduling plan transmitted by the automatic scheduling module and generate an executable production plan based on a current status of production devices, production progress, and execution conditions.

A scheduling plan refers to a production scheduling scheme generated according to order requirements, material status, equipment resources, and production capacity conditions, and is used to determine a production sequence, production-resource allocation, and time arrangement for products. For example, the scheduling plan may specify a production time period, a corresponding die, and a production sequence for a particular product on a designated unmanned stamping platform.

A production plan refers to a specific production arrangement generated based on the scheduling plan and used to specify production tasks to be completed by respective production resources within a predetermined time period. For example, the production plan may specify that the stamping line is to produce a designated quantity of target parts during a period from 8:00 a.m. to 12:00 p.m.

A production task refers to an operation instruction generated according to the production plan and issued to specific equipment for execution. For example, the production task may comprise an instruction issued to designated stamping equipment for processing a specified quantity of workpieces, or a corresponding transportation-operation instruction issued to an automated transport unit.

The device information module refers to a functional module configured to manage information associated with production devices.

The ERP platform (also referred to as an ERP system) refers to an information platform configured to integrate business data associated with enterprise production, procurement, inventory, sales, logistics, or the like, and to perform unified management of enterprise resources.

The production order module (also referred to as an order production module) refers to a functional module configured to input and manage production orders.

A production order refers to structured information comprising a product model, a production quantity, a delivery time, a production batch, customer requirements, or the like.

In some embodiments, the production order module may provide order data to the material data module.

The warehouse data module refers to a functional module configured to acquire and manage warehouse-related data.

The second material inventory module refers to a functional module provided in the ERP platform and configured to record and manage enterprise inventory data and synchronize inventory information with the intelligent manufacturing platform.

In some embodiments, the second material inventory module may transmit inventory data to the first material inventory module.

A bill of materials (BOM) refers to a collection of data used to describe a product's composition structure and material relationships thereof. For example, the BOM may comprise information regarding raw materials, components, quantity relationships, and hierarchical relationships corresponding to the product. The BOM is also referred to as a material BOM.

The automatic scheduling module is a module provided in the ERP platform for generating scheduling plans. In some embodiments, the automatic scheduling module may be configured to determine a scheduling plan according to production orders, inventory data, device-related information, and production constraints.

The production constraints refer to a set of limiting rules that are required to be observed during a production process with respect to time, resources, sequence, materials, processes, or the like.

In some embodiments, the automatic scheduling module may generate a scheduling plan and transmit the scheduling plan to the production scheduling module.

The unmanned stamping platform refers to an execution platform configured to automatically perform sheet-metal stamping operations and related production operations according to a production plan.

In some embodiments, the unmanned stamping platform may comprise an uncoiling blanking line, a stamping line, an automatic quality inspection module, an automatic packaging module, an automated storage and retrieval module, and an AGV module.

The uncoiling blanking line refers to an automated production line configured to perform uncoiling, leveling, feeding, and blanking operations on coiled material.

In some embodiments, the uncoiling blanking line may process coiled material into sheet-metal blanks that satisfy requirements of subsequent stamping processes according to the production plan.

The stamping line refers to an automated production line comprising stamping equipment and associated auxiliary devices and configured to perform stamping operations, such as blanking, drawing, bending, and forming, on sheet-metal blanks, thereby producing target products or components.

The automatic quality inspection (QA) module (also referred to as automatic quality detection) refers to a functional module configured to perform quality inspection on processed products.

The automatic packaging module (also referred to as automatic boxing) refers to a functional module configured to automatically package and box products that have passed quality inspection.

The automated storage and retrieval module (also referred to as stereoscopic storage) refers to a functional module configured to store and manage products by using automated warehousing equipment.

The automated guided vehicle (AGV) module (also referred to as an AGV system) refers to a logistics transportation module configured to control automated guided vehicles to perform transportation tasks.

In some embodiments, the AGV module comprises an automated transport unit and a scrap-removal guidance unit.

The automated transport unit (also referred to as an AGV automatic conveying system) refers to an automated guided vehicle configured to perform automatic material transportation tasks.

In some embodiments, the automated transport unit may transport raw materials, semi-finished products, finished products, material racks, or the like among production units such as the uncoiling blanking line, the stamping line, the automatic packaging module, and the automated storage and retrieval module, thereby enabling automated circulation of production logistics.

The scrap-removal guidance unit refers to an automated guided vehicle configured to perform automatic scrap-removal and transportation tasks.

In some embodiments, the scrap-removal guidance unit may automatically transport scrap generated during a stamping production process and collected in a scrap hopper to a designated area, thereby enabling unmanned scrap-removal operations.

In some embodiments, the unmanned intelligent manufacturing system is configured to realize unmanned intelligent manufacturing in an automotive stamping plant. Specifically, through coordinated operation of the intelligent manufacturing platform, the ERP platform, and the unmanned stamping platform, the unmanned intelligent manufacturing system automatically completes closed-loop management of an entire production process, including production-order reception, material management, production scheduling, stamping operations, quality inspection, finished-product packaging, automated storage and retrieval, and automatic material transportation, thereby reducing manual intervention and improving production efficiency and operational safety.

In some embodiments, the ERP platform is responsible for receiving production orders and managing inventory and bills of materials, and generates an initial scheduling plan through the automatic scheduling module. The scheduling plan is then transmitted to the intelligent manufacturing platform, which generates a specific production plan and corresponding production tasks based on device information and material status managed by the intelligent manufacturing platform. Subsequently, the production tasks are issued to respective execution units of the unmanned stamping platform. The unmanned stamping platform integrates the uncoiling blanking line, the stamping line, the automatic quality inspection module, the automatic packaging module, the automated storage and retrieval module, and the AGV module that comprises the automated transport unit and the scrap-removal guidance unit. During task execution, the uncoiling blanking line and the stamping line perform processing operations; the automated transport unit transports raw materials, semi-finished products, and finished products among different process stations; the automatic quality inspection module and the automatic packaging module inspect products and package qualified products; the automated storage and retrieval module stores the finished products; and the scrap-removal guidance unit automatically transports stamping scrap in the scrap hopper to the designated area. Meanwhile, the device information module provides relevant equipment parameters to the respective execution units in real time. Through data interaction and task coordination among the foregoing modules, qualified stamped products are ultimately produced, and data relating to production-execution progress, equipment operating status, material consumption, and inventory changes are synchronously generated for subsequent scheduling optimization and resource allocation, thereby realizing unmanned and intelligent closed-loop management of the stamping plant.

In some embodiments, the intelligent manufacturing platform further comprises an eccentricity detection array. The eccentricity detection array is configured to acquire a weight distribution matrix of stacked blanks and determine a center-of-gravity offset vector of the stacked blanks based on the weight distribution matrix. The production scheduling module is configured to generate motion control parameters based on the center-of-gravity offset vector and transmit the motion control parameters to the AGV module, wherein the motion control parameters comprise a centripetal-force threshold curve and acceleration step limits. The AGV module is configured to, under a turning condition, determine a target centripetal-force threshold from the centripetal-force threshold curve based on current operating parameters of the automated transport unit and limit an angular velocity of a steering motor of the automated transport unit based on the target centripetal-force threshold; and, under a braking condition, reduce output torque of drive wheels of the automated transport unit in stages based on the acceleration step limits or increase braking force applied to the drive wheels in stages. More details regarding the production scheduling module, the AGV module, and the automated transport unit are described above.

The eccentricity detection array refers to a hardware module configured to detect the weight distribution of stacked blanks and calculate the center-of-gravity offset vector thereof. In some embodiments, the eccentricity detection array is disposed below a roller conveyor of the uncoiling blanking line.

In some embodiments, the eccentricity detection array comprises a load-cell array and a processing unit.

The load-cell array refers to a sensor assembly comprising a plurality of weighing units distributed at different support points. A weighing unit refers to a sensor configured to measure weight. A support point refers to a mechanical measurement reference point used for determining material weight and the center-of-gravity offset vector.

In some embodiments, the load-cell array is configured to acquire the weight distribution matrix of the stacked blanks.

The processing unit refers to a hardware device configured to perform data reception and calculation of the center-of-gravity offset vector. For example, the processing unit may comprise a microprocessor, an industrial computer module, or the like.

In some embodiments, the processing unit receives the weight distribution matrix measured by the load-cell array and determines the center-of-gravity offset vector of the stacked blanks based on the weight distribution matrix.

The stacked blanks refer to a stack of metal sheets to be stamped, formed by cutting coiled steel sheets or aluminum sheets into predetermined shapes through the uncoiling blanking line and stacking the resulting blanks one on top of another.

The weight distribution matrix refers to a spatial data structure comprising coordinates of a plurality of support points and corresponding weight measurement values associated therewith.

In some embodiments, each weighing unit in the eccentricity detection array independently acquires a weight value at a corresponding support point, and measurement values of all weighing units are arranged according to spatial positions of the weighing units to form the weight distribution matrix.

The center-of-gravity offset vector refers to a distance magnitude and a direction vector from coordinates of a geometric center to coordinates of an actual physical center of gravity of the stacked blanks.

In some embodiments, the processing unit receives measurement values returned by respective weighing units in the load-cell array and constructs the weight distribution matrix based on installation coordinates of the respective weighing units. The processing unit determines a centroid of the weight distribution matrix through a moment-balance equation, thereby obtaining coordinates of the actual physical center of gravity of the stacked blanks. The processing unit then determines the center-of-gravity offset vector based on the coordinates of the actual physical center of gravity and coordinates of the geometric center.

Additional details regarding the geometric center are described below.

For example, the processing unit may obtain physical coordinates (xᵢ,yᵢ) of respective support points of the eccentricity detection array on a horizontal plane, together with corresponding weight values wᵢ measured by the sensors. Coordinates (X_{c},Y_{c}) of the actual physical center of gravity may be calculated using a centroid equation, as shown in Equation (1):

$${X}_{c} = \frac{\sum ( {w}_{i} \cdot {x}_{i} )}{\sum ( {x}_{i} )} , {Y}_{c} = \frac{\sum ( {w}_{i} \cdot {y}_{i} )}{\sum ( {y}_{i} )} . \qquad ( 1 )$$

In Equation (1), xᵢ,yᵢ represent physical coordinates of an i-th support point of the eccentricity detection array on the horizontal plane; and wᵢ represents a weight value measured by the weighing unit at the i-th support point, reflecting a local load of the blank borne by the support point. Coordinates (X_{g},Y_{g}) of the geometric center of the stacked blanks, which may be preset or derived through laser scanning, are then obtained. Subsequently, a two-dimensional vector subtraction is performed to obtain the center-of-gravity offset vector (X_{c}−X_{g}, Y_{c}−Y_{g}). A magnitude of the center-of-gravity offset vector represents a physical magnitude of eccentricity, while a direction angle of the center-of-gravity offset vector represents an orientation of heavy-load deviation.

The motion control parameters refer to a set of parameters generated by the production scheduling module based on the center-of-gravity offset vector and used to control movement behavior of the automated transport unit, thereby preventing rollover of the automated transport unit during turning under an eccentrically distributed heavy load and preventing loaded materials from slipping during abrupt braking.

The centripetal-force threshold curve refers to a curve describing a mapping relationship between a turning radius of the automated transport unit and a maximum allowable steering angular velocity.

In some embodiments, a horizontal axis of the centripetal-force threshold curve represents the turning radius, and a vertical axis of the centripetal-force threshold curve represents the maximum allowable steering angular velocity.

The acceleration step limits refer to a set of maximum braking-acceleration thresholds established in stages according to vehicle-speed intervals during braking. A maximum braking-acceleration threshold refers to an absolute value of a maximum allowable braking acceleration during a braking process, such that an actual braking acceleration is not permitted to exceed the maximum braking-acceleration threshold.

In some embodiments, the acceleration step limits are used to force the automated transport unit to perform staged braking and prohibit abrupt braking.

For example, the acceleration step limits may be configured as follows: when a vehicle speed exceeds 1.5 m/s, the maximum braking-acceleration threshold is 0.5 m/s²; when the vehicle speed falls within a range of 0.5 m/s to 1.5 m/s, the maximum braking-acceleration threshold is 1.0 m/s²; and when the vehicle speed is below 0.5 m/s, the maximum braking-acceleration threshold is 1.5 m/s².

In some embodiments, the production scheduling module may generate the motion control parameters based on the center-of-gravity offset vector in various manners. For example, the production scheduling module may query a parameter mapping table based on the current center-of-gravity offset vector, wherein a magnitude and a direction of the center-of-gravity offset vector are used as indices to obtain a corresponding centripetal-force threshold curve and acceleration step limits. The parameter mapping table may be established by a person having ordinary skill in the art based on experience.

In some embodiments, the production scheduling module may generate the motion control parameters based on the center-of-gravity offset vector through a parameter prediction model.

The parameter prediction model refers to a model configured to predict the motion control parameters. In some embodiments, the parameter prediction model may be a machine-learning model. For example, the parameter prediction model may include one or a combination of a Multilayer Perceptron (MLP) model, a Radial Basis Function Neural Network (RBF) model, and other customized models.

In some embodiments, inputs of the parameter prediction model may comprise the center-of-gravity offset vector and the weight distribution matrix, and outputs of the parameter prediction model may comprise the centripetal-force threshold curve and the acceleration step limits.

In some embodiments, the inputs of the parameter prediction model may further comprise a slip-resistance coefficient of a workshop floor and an interlayer shear-force parameter.

The slip-resistance coefficient refers to a quantitative indicator configured to characterize anti-slip performance between tires and a contact surface thereof after a floor of a stamping workshop is affected by deposition of volatilized oil contaminants. In some embodiments, the slip-resistance coefficient may be determined by detecting a reflectivity of the floor through a vision sensor or a spectral sensor deployed on the automated transport unit and querying a reflectivity-to-slip-resistance mapping relationship. The reflectivity-to-slip-resistance mapping relationship refers to a functional relationship or lookup table comprising correspondences between reflectivity values and slip-resistance coefficients. In some embodiments, the reflectivity-to-slip-resistance mapping relationship may be established through experimental calibration.

The interlayer shear-force parameter refers to a critical shear-stress threshold that must be overcome to cause relative sliding between adjacent steel plates due to the presence of an anti-rust oil layer during stacking of the steel plates.

In some embodiments, the production scheduling module may acquire a material type of the steel plates and a model of a surface anti-rust oil (also referred to as a surface anti-rust oil model) from the bill of materials in the ERP platform, and retrieve, from a preset database, an interlayer shear-force reference value corresponding to the material type and the surface anti-rust oil model as the interlayer shear-force parameter. The database refers to a pre-established collection of data configured to store correspondences among steel-plate material types, surface anti-rust oil models, and interlayer shear-force reference values. Interlayer shear-force reference values corresponding to different steel-plate material types and different anti-rust oil models may be determined in advance through experimental measurements.

In some embodiments, the parameter prediction model may be obtained by training an initial parameter prediction model using a plurality of first training samples associated with first labels. Each first training sample may comprise a sample center-of-gravity offset vector, a sample weight distribution matrix, a sample slip-resistance coefficient, and a sample interlayer shear-force parameter. The first labels may comprise motion control parameters corresponding to the respective first training samples.

In some embodiments, the first training samples may be constructed as follows. Historical actual physical drop-event data and test data generated when the automated transport unit experiences tire slippage or material lateral displacement within a stamping workshop are collected, and operating data that did not result in rollover or material drop-off are screened therefrom. Based on the screened operating data, sample center-of-gravity offset vectors, sample weight distribution matrices, sample slip-resistance coefficients, and sample interlayer shear-force parameters are extracted to jointly form the first training samples. Correspondingly, the first labels are actual motion control parameters corresponding to the first training samples and may be determined by querying logs of the AGV module.

In some embodiments, the production scheduling module may input a plurality of first training samples associated with first labels into the initial parameter prediction model. A loss function is constructed based on the first labels and output results of the initial parameter prediction model, and parameters of the initial parameter prediction model are iteratively updated based on the loss function through gradient descent or other optimization techniques. When a preset condition is satisfied, model training is completed, thereby obtaining a trained parameter prediction model. The preset condition may comprise convergence of the loss function, a number of iterations reaching a threshold, or the like.

In some embodiments, the loss function may be a mean squared error between prediction results of the initial parameter prediction model and corresponding first labels.

The turning condition refers to a state in which the automated transport unit moves along a curved path.

The current operating parameters refer to real-time status data of the automated transport unit during movement. For example, the current operating parameters may comprise linear velocity, acceleration, steering angular velocity, a turning radius, or the like.

In some embodiments, the current operating parameters may be obtained through various sensors or encoders deployed on the automated transport unit. For example, the AGV module may measure a linear velocity of the automated transport unit through a drive-wheel motor encoder. As another example, the AGV module may obtain a steering angular velocity of the automated transport unit through a steering-motor encoder. As yet another example, the AGV module may obtain a linear velocity v through the drive-wheel motor encoder and obtain a steering angular velocity ω through the steering-motor encoder or an inertial measurement unit (IMU), and calculate a turning radius at a current time according to R=v/ω, where R represents the turning radius, v represents the linear velocity of the automated transport unit, and ω represents the steering angular velocity of the automated transport unit.

The target centripetal-force threshold refers to a currently allowable maximum steering angular velocity obtained from the centripetal-force threshold curve according to the current operating parameters.

In some embodiments, the AGV module may query the centripetal-force threshold curve based on the turning radius included in the current operating parameters of the automated transport unit and determine the obtained maximum steering angular velocity as the target centripetal-force threshold.

The steering motor refers to an actuator configured to drive deflection of a steerable wheel of the automated transport unit.

The steering angular velocity refers to a rate of change of a steering angle by which the steering motor causes the steerable wheel to deflect.

In some embodiments, under a turning condition, the AGV module may acquire the steering angular velocity in real time through the steering-motor encoder of the automated transport unit. When a current steering angular velocity of the automated transport unit exceeds the target centripetal-force threshold, the AGV module performs hardware truncation through a clamping algorithm, thereby dynamically limiting an actual steering angular velocity within a maximum range permitted by the centripetal-force threshold curve, so as to counteract an overturning moment caused by a center-of-gravity offset.

The clamping algorithm refers to a numerical processing technique configured to constrain an input value within a preset upper-limit range and lower-limit range. When the input value exceeds an upper limit, the upper-limit value is output; when the input value is below a lower limit, the lower-limit value is output; and when the input value falls within the range, the input value itself is output.

The braking condition refers to an operating state in which the automated transport unit decelerates from a moving state to a stop or to a reduced speed.

A drive wheel refers to a power-output wheel of the automated transport unit. Output torque refers to a rotational torque applied by a drive motor to the drive wheel.

The braking force refers to a resistive torque applied to a drive wheel or a driven wheel of the automated transport unit.

In some embodiments, under the braking condition, the AGV module may measure a linear velocity of the automated transport unit through a drive-wheel motor encoder and query, from the acceleration step limits, a maximum braking-acceleration threshold corresponding to the current linear velocity. Subsequently, the AGV module may issue a staged decreasing output torque to the drive wheels of the automated transport unit, or apply, through a mechanical braking device, a braking force corresponding to the maximum braking-acceleration threshold to the drive wheels of the automated transport unit, such that a deceleration process is forcibly executed in a staged and gradual manner, thereby preventing blanks carried by the automated transport unit from sliding or falling due to excessive output torque or excessively aggressive braking force.

The mechanical braking device refers to an actuator configured to apply a braking force to a drive wheel or a transmission shaft of the automated transport unit through mechanical friction.

In some embodiments of the present disclosure, the center-of-gravity offset vector of stacked blanks is acquired through the eccentricity detection array, and the motion control parameters comprising the centripetal-force threshold curve and the acceleration step limits are generated based thereon, such that the automated transport unit actively limits its steering angular velocity during turning and performs staged deceleration during braking. Accordingly, problems associated with rollover and material drop-off during transportation of heavy-load, eccentrically loaded, and irregularly shaped blanks in a factory environment can be effectively addressed, thereby significantly improving transportation safety and equipment survivability.

In some embodiments of the present disclosure, the ERP platform is provided in the unmanned intelligent manufacturing system, such that collected market-sales data are transmitted to the intelligent manufacturing platform. The intelligent manufacturing platform controls the unmanned stamping platform and adjusts workshop production decisions, such as prioritizing production volume or prioritizing production of a new vehicle model, and reasonably allocates auxiliary workshop resources according to actual requirements. Accordingly, automated manufacturing can be achieved, thereby overcoming limitations associated with manual production planning. The unmanned intelligent manufacturing system provides advantages associated with automated manufacturing, such that extensive manual operations by a large number of workers are no longer required, thereby reducing labor intensity and saving time costs.

In some embodiments, the production scheduling module is further configured to acquire, through a contour scanning device, an outer contour cross-section corresponding to the stacked blanks after each blanking operation; sequentially extract a boundary deviation between each two adjacent outer contour cross-sections to obtain a set of boundary deviations; determine a cumulative slip vector based on the set of boundary deviations; generate a spatial envelope based on an initial outer contour cross-section and the cumulative slip vector; and determine a volumetric centroid of the spatial envelope and designate the volumetric centroid as the geometric center.

Additional details regarding the production scheduling module are described above.

The contour scanning device refers to a sensing device configured to acquire point-cloud data representing an outer-surface profile of stacked blanks. For example, the contour scanning device may comprise a laser scanner.

In some embodiments, the contour scanning device is mounted above the uncoiling blanking line.

An outer contour cross-section refers to two-dimensional closed outer-edge curve data characterizing a single blank in a horizontal X-Y plane.

In some embodiments, the production scheduling module is configured to transmit a trigger pulse to the contour scanning device each time the uncoiling blanking line performs a blanking operation and stacks a single blank onto the stacked blanks. After receiving the trigger pulse, the contour scanning device scans an uppermost surface layer of the current stacked blanks, extracts edge-boundary features from point-cloud data of the surface layer, and generates an outer contour cross-section in the horizontal X-Y plane with associated Z-axis height information.

A boundary deviation refers to a translational deviation and a rotational deviation between outer contour cross-sections of two adjacent blanks in a horizontal direction along a stacking direction.

In some embodiments, the production scheduling module may perform coordinate-domain matching and comparison between a current outer contour cross-section of an N-th layer and a cached outer contour cross-section of an (N−1)-th layer, extract a two-dimensional displacement vector between geometric centers thereof, and use the two-dimensional displacement vector as the boundary deviation between the N-th layer and the (N−1)-th layer.

The set of boundary deviations refers to a collection of boundary deviations between all adjacent outer contour cross-sections.

The cumulative slip vector refers to a total deviation vector obtained by performing vector summation, within a spatial coordinate system, of boundary deviations of respective layers from a bottommost blank to a topmost blank in the stacked blanks.

In some embodiments, the production scheduling module may determine the cumulative slip vector through vector addition based on the boundary-deviation-degree set.

The spatial coordinate system refers to a coordinate system configured to describe positions and orientations of the stacked blanks in three-dimensional space. In some embodiments, an origin of the spatial coordinate system may be defined at a geometric center of a lower surface of a bottommost blank, wherein X-axis and Y-axis directions lie within a horizontal plane, and a Z-axis direction extends upwardly perpendicular to the horizontal plane and corresponds to a stacking-height direction of the blanks.

The initial outer contour cross-section refers to an outer contour cross-section acquired from the stacked blanks after a first blanking operation.

The spatial envelope refers to a three-dimensional geometric fitting model configured to characterize an outer boundary of the entire stacked blanks and may also be referred to as a three-dimensional spatial envelope.

In some embodiments, within the spatial coordinate system, the production scheduling module uses the initial outer contour cross-section as a basis and performs layered assembly of respective outer contour cross-sections according to corresponding Z-axis height information and corresponding cumulative slip vectors thereof. Discrete two-dimensional sectional edge points are then fitted using a convex-hull algorithm or a bounding-box algorithm, thereby generating a spatial envelope representing an actual physical boundary of the stacked blanks after misalignment occurs. The Z-axis height information reflects a total height comprising an inherent thickness of sheet material and interlayer microscopic suspension gaps generated by shear stresses associated with surface anti-rust oil films on the sheet material, thereby ensuring that the three-dimensional spatial envelope accurately reconstructs a physical deformation boundary.

In some embodiments, the production scheduling module performs volumetric-center calculation on the generated three-dimensional spatial envelope through a calculus-based algorithm, namely, by integrating products of coordinate variables in respective dimensions and differential volume elements and dividing resulting values by a total volume. Coordinates of the resulting volumetric centroid are output and used as a reference geometric center for determining the center-of-gravity offset vector.

In some embodiments of the present disclosure, the outer contour cross-sections are acquired layer by layer, the boundary deviations between adjacent layers are calculated, and the cumulative slip vector is determined, thereby generating the three-dimensional spatial envelope. The volumetric centroid of the three-dimensional spatial envelope is then used as the geometric center. This solution overcomes limitations of conventional idealized rectangular-solid models by quantifying interlayer microscopic slip as cumulative displacement and reconstructing an actual shape of distorted stacked blanks, thereby enabling highly accurate determination of the geometric center and substantially eliminating error interference caused by stack deformation in calculation of the center-of-gravity offset vector.

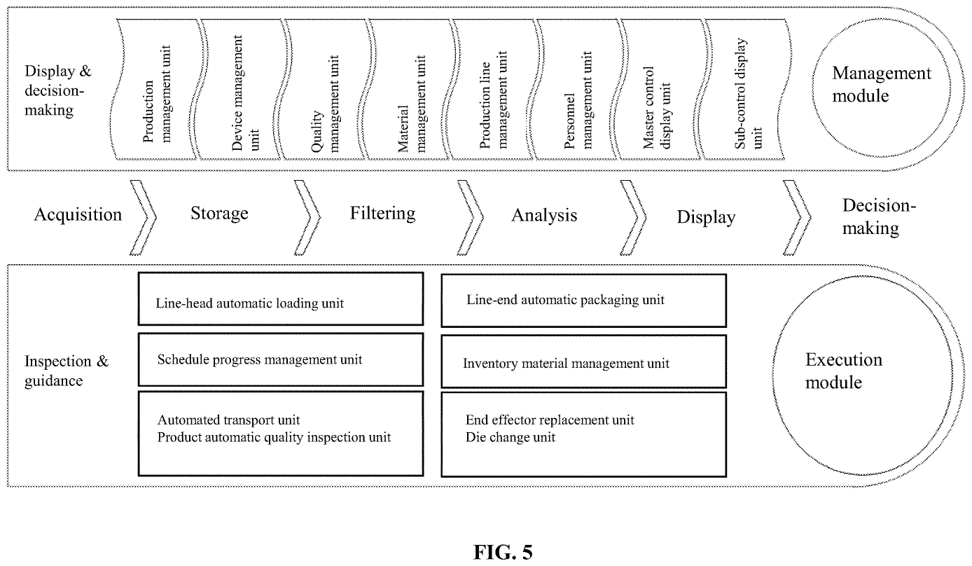

FIG. 5 is an architectural system diagram of an intelligent manufacturing platform according to some embodiments of the present disclosure.

In some embodiments, as shown in FIG. 5, the intelligent manufacturing platform internally comprises a management module and an execution module. The management module comprises a production management unit, a device management unit, a quality management unit, a material management unit, a production line management unit, a personnel management unit, a master control display unit, and a sub-control display unit. The execution module comprises a line-head automatic loading unit, a schedule progress management unit, the automated transport unit, a product automatic quality inspection unit, a line-end automatic packaging unit, an inventory material management unit, an end effector replacement unit, and a die change unit

In some embodiments of the present disclosure, by providing the management system, the unmanned stamping line can be monitored, thereby facilitating management by supervisory personnel.

Additional details regarding the automated transport unit are described above.

The management module (also referred to as a management system) refers to a functional module configured to uniformly monitor, coordinate, and manage production resources, production activities, and operating states of the unmanned stamping platform during a production process.

The production management unit (also referred to as production management) refers to a functional unit configured to manage production tasks, production plans, and production-execution status.

The device management device (also referred to as device management) refers to a functional unit configured to manage operating states, maintenance information, and fault information of production devices.

The quality management unit (also referred to as quality management) refers to a functional unit configured to manage product quality data, quality-inspection results, and quality-abnormality information.

The material management unit (also referred to as material management) refers to a functional unit configured to manage requisition, consumption, circulation, and inventory status of production materials.

The production line management unit (also referred to as production line management) refers to a functional unit configured to manage operating states, production-capacity conditions, and process-execution status of production lines.

A production line refers to a collection of equipment arranged according to a predetermined process flow and configured to cooperatively perform product manufacturing operations, thereby enabling continuous production of workpieces from raw materials to finished products.

The personnel management unit (also referred to as personnel management) refers to a functional unit configured to manage position information, authorization information, and operational information of production-related personnel.

The master control display unit (also referred to as master control presentation) refers to a functional unit configured to centrally display overall factory production and operation information.

The sub-control display unit (also referred to as slave control presentation) refers to a functional unit configured to display operating information of designated production areas, equipment, or processes in a categorized manner.

The execution module (also referred to as an execution system) refers to a functional module configured to drive respective automated devices to perform production operations according to a production plan.

The line-head automatic loading unit (also referred to as a line head automatic feeding system) refers to a functional unit configured to automatically convey materials to be processed to an entry position of a production line.

The schedule progress management unit (also referred to as a planned process management system) refers to a functional unit configured to track execution progress of a production plan and provide feedback regarding production-completion status.

The product automatic quality inspection unit (also referred to as a product automatic quality detection system) refers to a functional unit configured to automatically inspect product quality and output inspection results.

The line-end automatic packaging unit (also referred to as a line tail automatic boxing system) refers to a functional unit configured to automatically organize, package, and output processed products.

The inventory material management unit (also referred to as an inventory material management system) refers to a functional unit configured to perform storage recording, inbound/outbound inventory control, and inventory monitoring for inventory materials.

The end effector replacement unit (also referred to as an end picking-up device automatic changing system) refers to a functional unit configured to automatically replace an end effector of a robot according to production requirements.

The end effector refers to a terminal operating device mounted at an end of a robot and configured to grasp, clamp, adsorb, or transport a workpiece.

The die change unit (also referred to as a mold storage and changing system) refers to a functional unit configured to store, retrieve, transport, and automatically replace stamping dies. In some embodiments, the management module and the execution module are capable of communicating with each other, and data interaction is also supported among respective units within the management module and among respective units within the execution module.

In some embodiments, the automated transport unit is an intelligent unmanned forklift or a trackless intelligent automated guided cart, and a transport weight of the automated transport unit is less than five tons.

In some embodiments of the present disclosure, by providing the automated transport unit, transportation tasks for raw materials, semi-finished products, or finished products among different workstations may be automatically completed according to production tasks, thereby reducing manual handling of materials, improving material-circulation efficiency, and reducing transportation errors during material handling.

In some embodiments, the intelligent manufacturing platform further comprises an edge control node communicatively connected to the production scheduling module and the management module. The production scheduling module is configured to package action instructions comprising a plurality of consecutive process-operation nodes into a time-sequenced action sequence and issue the time-sequenced action sequence to a task buffer pool of the edge control node. The edge control node is configured to acquire crank phase-angle data of a main transmission mechanism of the stamping line; define an electromagnetic blind window based on the crank phase-angle data and a heavy-load stamping sequence; transmit monitoring packets to the production scheduling module and the management module at a preset frequency; and trigger a stamping disconnection event when a number of consecutive lost packets exceeds a packet-loss threshold. In response to triggering the stamping disconnection event, the edge control node is further configured to execute differentiated degradation control.

Additional details regarding the production scheduling module, communications with the management module, and the stamping line are described above.

In some embodiments, a network architecture of the unmanned intelligent manufacturing system adopts a cloud-edge collaborative three-layer topology, which is hierarchically divided into a cloud layer, an edge layer, and an endpoint layer. The cloud layer comprises the production scheduling module and the management module and is responsible for global scheduling and task issuance. The edge layer comprises the edge control node and is responsible for on-site real-time control and autonomous operation during disconnection events. The endpoint layer comprises underlying execution devices such as the automated transport unit and robotic arms. Within the foregoing architecture, two communication links having different characteristics are provided, namely, an uplink wide-area communication link and a downlink local-area communication link.

The uplink wide-area communication link refers to a communication connection of the edge control node with the production scheduling module and management module. The uplink wide-area communication link spans a relatively long distance and may employ a standard industrial wireless network, such as Wi-Fi, 5G, or the like. The uplink wide-area communication link is a vulnerable communication link susceptible to interference from stamping-generated electromagnetic pulses.

The downlink local-area communication link refers to a control communication connection of the edge control node with the robotic arms and automated transport units. The downlink local-area communication link employs localized physical communication technologies such as high-frequency directional antennas, short-range high-energy Bluetooth communications, industrial field buses, or the like, and exhibits characteristics including short transmission distance, high signal strength, and strong resistance to electromagnetic interference.

The edge control node refers to an industrial control hardware device having localized computing capability and logical takeover capability. For example, the edge control node may comprise an embedded controller deployed in an on-site control cabinet of the stamping line.

In some embodiments, the edge control node is installed adjacent to physical equipment within a stamping workshop.

An action instruction refers to a command that instructs a specific execution unit in the unmanned stamping platform (e.g., a robotic arm or stamping equipment) to complete a single process-operation node.

The process-operation node refers to a process-step unit in an unmanned stamping production flow that has clearly defined start and end boundaries and can be independently described and executed.

The time-sequenced action sequence refers to a data set comprising action instructions corresponding to a plurality of serially connected process-operation nodes and execution-timing labels thereof. The time-sequenced action sequence may be represented as: [Step 1: Action 1, Step 2: Action 2, . . . , Step n: Action n]. For example, the time-sequenced action sequence may be: [Step 1: move forward to pick up material, Step 2: lift and retract, . . . , Step n: return to the original position].

The task buffer pool refers to an instruction-queue storage area allocated in local memory of the edge control node and configured to temporarily store time-sequenced action sequences issued by the production scheduling module. In some embodiments, the edge control node distributes the time-sequenced action sequences stored in the task buffer pool to corresponding execution units, such as robotic arms or drivers of automated transport units, according to the execution sequence.

In some embodiments, an upper limit on the number of instructions stored in the task buffer pool may be adjusted according to actual requirements.

The upper limit on the number of instructions refers to a maximum number of unexecuted action instructions that are allowed to remain temporarily stored in the task buffer pool, namely, a maximum queue depth.

In some embodiments, the edge control node periodically reads a status-register value and a spindle rotational speed of a programmable logic controller (PLC) of a master controller of a stamping press and converts the spindle rotational speed into a real-time stamping frequency. The real-time stamping frequency refers to a number of stamping operations performed by the stamping press per unit time and is expressed in strokes per minute (SPM). The production scheduling module compares the status-register value and the real-time stamping frequency with preset thresholds and accordingly triggers differentiated caching strategies. Specifically, Strategy 1 is a cache-expansion strategy under a high-frequency operating condition. When the PLC status-register value indicates a “continuous automatic stamping mode” and the real-time stamping frequency exceeds a first frequency threshold, the current operating environment is determined to be a stable mass-production environment having an extremely high production cadence and frequent high-frequency electromagnetic interference. In this case, the edge control node issues a memory-expansion instruction to a memory-management module, thereby dynamically increasing the upper limit on the number of instructions to a first depth threshold (e.g., fifteen instructions). Accordingly, even if communication with a master server is temporarily interrupted due to high-frequency pulse interference, local robotic arms and automated transport units still possess a sufficient reserve of pre-stored time-sequenced action sequences to maintain continuous production operation and prevent production-line stoppage caused by the disconnection. Strategy 2 is a cache-blocking strategy under a high-risk operating condition. When the PLC status-register value indicates a “single-stroke stamping mode” or an “inching stamping mode,” or when the real-time stamping frequency falls below a second frequency threshold, the workshop is determined to be in a potentially hazardous stage, such as heavy-load die testing, manual maintenance intervention, or fault-recovery crawling operation. In this case, the edge control node issues a capacity-truncation instruction to the memory-management module, thereby forcibly reducing the upper limit on the number of instructions to a second depth threshold (e.g., retaining only one cached instruction). As a result, risks associated with physical interference or collision between devices are eliminated, where such risks could otherwise arise because a large number of obsolete action instructions remain in the task buffer pool and cannot be withdrawn by a master controller in a timely manner during an emergency.

The memory-management module refers to a component within a real-time operating system of the edge control node that is responsible for dynamically allocating and reclaiming memory space and managing capacities of queue buffers. The capacity-truncation instruction refers to a control instruction configured to forcibly and immediately reduce the upper limit on the number of instructions in the task buffer pool to the preset second depth threshold.

The first frequency threshold refers to an upper stamping-frequency determination value used to determine whether the stamping line has entered a high-frequency operating condition. The second frequency threshold refers to a lower stamping-frequency determination value used to determine whether the stamping line has entered a high-risk operating condition. The first depth threshold refers to a maximum queue-depth value to which the upper limit on the number of instructions in the task buffer pool is dynamically expanded under the high-frequency operating condition. The second depth threshold refers to a minimum queue-depth value to which the upper limit on the number of instructions in the task buffer pool is forcibly reduced under the high-risk operating condition. In some embodiments, the first frequency threshold, the second frequency threshold, the first depth threshold, and the second depth threshold may be preset by those skilled in the art based on experience.

The main transmission mechanism refers to a core power-transmission and motion-conversion assembly of the stamping line. In some embodiments, the main transmission mechanism may comprise a high-power motor, a flywheel, a clutch, a brake, and a crank-linkage system.

The crank phase-angle data refers to angular data representing a current rotational position of the main transmission mechanism, having a value range of [0°, 360°].

In some embodiments, the crank phase-angle data may comprise rotational-angle information continuously acquired by an absolute encoder mounted on a crankshaft of the main transmission mechanism.

The heavy-load stamping sequence refers to a time-space mapping relationship that defines phase-angle intervals at which physical heavy-load conditions occur, corresponding durations, and impact intensities within a complete stamping cycle (i.e., 360° rotation of the crank).

By way of example, when an automobile door is being processed and a real-time stamping frequency of the main transmission mechanism is 15 SPM, completion of one full stamping cycle requires 4 seconds (i.e., 4000 milliseconds). The real-time stamping frequency is first converted into a standard angular velocity, namely, 360°/4000 ms=0.09°/ms, indicating that each 1° of rotation requires approximately 11.11 ms. The heavy-load stamping sequence may be represented as: [(0°-160°) unloaded downward-travel stage, (160°-180°) heavy-load forming stage, (180°-190°) heavy-load demolding stage, and (190°-360°) unloaded return stage]. When a die rapidly moves downward without load within the crank-angle interval from 0° to 160°, the motor operates smoothly and workshop communications remain unobstructed, corresponding to a time interval of 0 ms to 1777 ms. When the crank phase-angle data enters the heavy-load forming stage from 160° to 180°, an upper die forcefully impacts a steel sheet and plastically deforms the steel sheet. At this time, the main motor instantaneously generates a peak compensating current to overcome substantial metal-deformation resistance, thereby producing the strongest electromagnetic-pulse interference, corresponding to a time interval of 1777 ms to 2000 ms. Subsequently, during the heavy-load demolding stage from 180° to 190°, the die is withdrawn from the formed part. The motor remains under a high-load condition, and residual electromagnetic-pulse interference continues to exist, corresponding to a time interval of 2000 ms to 2111 ms. From 190° to 360° (i.e., returning to) 0°, the die is completely disengaged and returns under an unloaded condition. Motor current decreases and electromagnetic-pulse interference disappears completely, corresponding to a time interval of 2112 ms to 4000 ms.

The electromagnetic blind window refers to a time window during a heavy-load stage in which intense electromagnetic-pulse interference is generated due to factors such as substantial mechanical impact, high-current driving, and closure of a metallic die cavity, thereby causing a temporary and predictable failure of the on-site uplink wide-area communication link.

In some embodiments, the edge control node reads crank phase-angle data fed back by the absolute encoder of the main transmission mechanism of the stamping line to obtain a current crank position within a 360° cycle. Meanwhile, the edge control node retrieves phase intervals corresponding to stages during which a die contacts and compresses a sheet material in the heavy-load stamping sequence (i.e., the heavy-load forming stage and the heavy-load demolding stage), for example, from 160° to 190°, and defines a time window during which the crank moves within the phase interval as the electromagnetic blind window.

To accurately capture phase-related patterns of electromagnetic interference occurring during actual production, in some embodiments, the edge control node retrieves actual crank phase-angle data corresponding to network-disconnection events that occurred during historical continuous production cycles and fits the data using a Gaussian distribution to generate a probability-distribution model of electromagnetic-interference occurrence phases, denoted as N(μ, σ²). The mean value u represents a central phase at which electromagnetic-pulse interference most frequently occurs, and the standard deviation o represents a degree of dispersion of phases at which electromagnetic-pulse interference occurs. Subsequently, the edge control node determines a phase interval [μ−3σ, μ+3σ] by extending a width of 3σ on each side of the mean value μ, thereby covering historical interference events. Considering that unexpected abnormal operating conditions, such as die-edge chipping or power-grid surges, may cause random shifts in electromagnetic-interference phases, a preset random-jitter redundant phase angle (e.g., ±5°) is additionally superimposed on outer boundaries of the 3σ interval to form a final composite phase interval [μ−3σ−Δ, μ+3σ+Δ], where Δ represents the random-jitter redundant phase angle. Thereafter, the edge control node maps the composite phase interval to a time window according to the crank phase-angle data and the heavy-load stamping sequence. Specifically, based on the heavy-load stamping sequence and the real-time stamping frequency, the edge control node determines, for each future stamping cycle, a corresponding time interval during which the crank phase angle falls within the phase interval [μ−3σ−Δ, μ+3σ+Δ], and designates the time interval as an electromagnetic-pulse blind window.

In some embodiments, the edge control node is further configured to adjust the electromagnetic blind window based on the crank phase-angle data, the heavy-load stamping sequence, and a smooth frequency-reduction curve.

Additional details regarding the smooth frequency-reduction curve are described below.

When the production scheduling module triggers frequency-reduced operation of the stamping line while waiting for a scrap-removal guidance unit, an original electromagnetic-pulse blind-window range defined based on a rated stamping frequency is no longer applicable. Accordingly, in some embodiments, the edge control node dynamically adjusts the blind-window range through the following process. The edge control node reads a smooth frequency-reduction curve generated by the production scheduling module, updates the heavy-load stamping sequence according to the smooth frequency-reduction curve using a preset algorithm, and then recalculates the electromagnetic blind window based on the crank phase-angle data and the updated heavy-load stamping sequence.

In some embodiments of the present disclosure, when the stamping line operates at a variable speed due to process requirements or abnormal-condition handling, particularly during frequency-reduction operation, a fixed electromagnetic blind-window range may become inaccurate, thereby causing erroneous triggering or failure of safety-control logic. By introducing the smooth frequency-reduction curve to adjust the electromagnetic blind window, accuracy in determining a nature of a communication interruption under variable-speed operating conditions is ensured. As a result, unnecessary shutdowns are avoided while protection is maintained during genuinely hazardous intervals, thereby significantly improving safety and availability under varying operating conditions.

The preset frequency refers to a heartbeat-packet or monitoring-packet transmission frequency agreed upon between the edge control node and the production scheduling module and management module for confirming survivability of the uplink wide-area communication link. For example, a monitoring packet may be transmitted once every 10 ms.

In some embodiments, the preset frequency is manually preset.

A monitoring packet refers to a network-status data packet actively transmitted by the edge control node to the production scheduling module and the management module at the preset frequency.

The number of consecutive lost packets refers to a cumulative number of times that the edge control node consecutively fails to receive valid responses from the production scheduling module and the management module to monitoring packets during a monitoring process.

In some embodiments, the number of consecutive lost packets is a dynamically updated real-time metric. Each successful handshake resets the consecutive packet-loss count to zero, while each response timeout increments the consecutive packet-loss count by one.

The packet-loss threshold refers to a tolerance limit for the number of consecutive lost packets used to determine that the uplink wide-area communication link has been disconnected.

In some embodiments, when the counted value of the number of consecutive lost packets exceeds the packet-loss threshold, an intolerable interruption of the uplink wide-area communication link is determined to have occurred, and a stamping disconnection event is triggered.

In some embodiments, the packet-loss threshold may be manually preset according to actual operating conditions.

In some embodiments, the packet-loss threshold is configured to balance robustness against transient interference and timeliness of fault response, thereby preventing the system from entering a degradation-control mode in an overly sensitive manner due to occasional and short-duration packet-loss events.

A stamping disconnection event refers to a trigger indication representing an abnormal interruption of the uplink wide-area communication link.

In some embodiments, even after the uplink wide-area communication link is interrupted, the local downlink local-area communication link remains intact.

The differentiated degradation control refers to a safety-control paradigm in which, after a stamping disconnection event occurs, the edge control node adopts different handling strategies according to a specific spatiotemporal context in which the disconnection occurs and a current task status of equipment.

In some embodiments, the edge control node is further configured to: in response to determining that the stamping disconnection event occurs within the electromagnetic blind window, intercept an emergency braking signal of the automated transport unit, and determine a feedforward inertial coasting curve based on wheel-speed data at a moment immediately preceding the occurrence of the stamping disconnection event; control, based on the feedforward inertial coasting curve, the automated transport unit to maintain an original trajectory and traverse the electromagnetic blind window, and re-establish communication after exiting the electromagnetic blind window; in response to determining that the stamping disconnection event occurs outside the electromagnetic blind window, determine that the stamping disconnection event is a genuine communication-link failure; in response to determining that the stamping disconnection event is the genuine communication-link failure, terminate execution of a current task, and control a robotic arm to skip the action instructions in the task buffer pool that have not yet been executed; control the robotic arm, based on an avoidance trajectory, to retreat along the avoidance trajectory to a die safety zone; and execute servo braking after the robotic arm enters the die safety zone.

The emergency braking signal refers to a highest-priority stop command automatically triggered by the default safety logic of the automated transport unit upon determination that a stamping disconnection event has occurred. For example, the emergency braking signal may include disabling servo enablement, applying maximum-torque locking, or immediately performing reverse braking.

In some embodiments, the edge control node may arrange an AND gate or a conditional switch in a generation path of the emergency braking command triggered by a communication interruption. Only when the stamping disconnection event is determined to have occurred within the electromagnetic blind window is the emergency braking signal intercepted and not actually issued to the driver of the automated transport unit, thereby preventing the automated transport unit from coming to an abrupt stop.

The wheel-speed data refers to real-time rotational-speed information of each drive wheel of the automated transport unit. In some embodiments, the wheel-speed data may be acquired by encoders or Hall-effect sensors installed on drive motors or wheel hubs.

In some embodiments, upon occurrence of the disconnection event, the edge control node directly reads encoder feedback pulses or speed values from the driver of the automated transport unit.

The feedforward inertial coasting curve refers to a speed control curve configured to enable the automated transport unit to decelerate smoothly by relying on mechanical inertia without changing a predetermined path-following direction. In some embodiments, the horizontal axis of the feedforward inertial coasting curve represents time, and the vertical axis represents speed.

In some embodiments, when a stamping disconnection event is triggered and determined to have occurred within the electromagnetic blind window, the edge control node immediately acquires an actual wheel speed v₀ of the automated transport unit and a total loaded mass m at a moment immediately preceding the occurrence of the stamping disconnection event, and retrieves a pre-stored equivalent physical resistance F_{friction} combining drivetrain damping and a ground rolling-friction resistance coefficient. Based on Newton's second law and a kinetic-energy attenuation principle, a differential equation describing speed as a function of time is established as follows:

$$V ( t ) = {v}_{0} - \int \frac{{F}_{friction}}{m} dt ,$$

thereby deriving a speed attenuation curve of the automated transport unit when active driving force from the motor is removed and the automated transport unit coasts solely under mechanical inertia. The speed attenuation curve describes a complete trajectory in which, within a time window of several milliseconds corresponding to the electromagnetic blind window, the speed of the transport unit decreases smoothly and substantially linearly from the initial value v₀ under the action of the constant physical resistance. The edge control node then determines the speed attenuation curve as the feedforward inertial coasting curve.

In some embodiments, the edge control node generates continuous motor torque commands or speed commands locally according to the feedforward inertial coasting curve, and continuously transmits the commands to a controller of the automated transport unit through a local bus, thereby controlling the automated transport unit to maintain its original trajectory while traversing the electromagnetic blind window.

Re-establishing communication refers to a process in which, after the automated transport unit exits the electromagnetic blind window and the wireless communication link is restored, the edge control node and the production scheduling module and/or management module re-establish normal communication connections and state synchronization.

A genuine communication-link failure refers to an irrecoverable link failure caused by actual physical or network equipment problems, such as equipment damage, cable breakage, or switch failure.

The current task refers to an action instruction that is being executed by the robotic arm and has not yet been completed when the genuine communication-link failure occurs.

In some embodiments, after determining that a genuine communication-link failure has occurred and terminating the current task, the edge control node reviews the local task buffer pool and rapidly traverses action instructions queued therein that are marked with a status of “pending execution,” and marks the action instructions as “skipped” or “aborted.”

The avoidance trajectory refers to a spatial motion path preconfigured in a local controller of the robotic arm for enabling the robotic arm to retreat rapidly and safely from a hazardous area, such as an interior or peripheral region of a stamping die, to the die safety zone.

In some embodiments, the avoidance trajectory is preset by a person skilled in the art according to actual workshop conditions.

The die safety zone refers to a physically safe parking area that cannot be interfered with by a die.

In some embodiments, the die safety zone is geometrically guaranteed such that, regardless of how the die opens or closes, the robotic arm entering the die safety zone does not experience any interference or collision with the die.

In some embodiments, the die safety zone is preset manually.

The servo braking refers to a braking mechanism that maintains a servo motor and a load thereof in a mechanically locked state when power is removed or the system is shut down.

In some embodiments, after the robotic arm retreats to the die safety zone along the avoidance trajectory, the edge control node immediately issues disable-enable commands and brake-engagement commands to drivers of all joints of the robotic arm. The drivers cut off power to the motors, and the brakes lock all joints, thereby rigidly fixing the entire robotic arm and ensuring absolute immobility so as to prevent accidental displacement.

In some embodiments of the present disclosure, differential degradation control based on a location at which a stamping disconnection event occurs (i.e., inside or outside the electromagnetic blind window) changes the conventional “one-size-fits-all” safety strategy of “stop upon any disconnection.” For predictable interference occurring within the electromagnetic blind window, inertial traversal is utilized to maintain production continuity, thereby avoiding unnecessary production interruptions and dangerous abrupt stops between dies. For a genuine communication-link failure, the current task is rapidly terminated, the robotic arm is retracted to the die safety zone, and servo braking is performed, thereby maintaining production continuity to the greatest extent possible while ensuring the highest level of safety and achieving an intelligent balance between safety and production efficiency.

In some embodiments, the edge control node is further configured to: determine asymmetric holding torques based on the center-of-gravity offset vector; and, when the automated transport unit enters the electromagnetic blind window and loses network control, issue the asymmetric holding torques to left and right drive wheels of the automated transport unit.

The asymmetric holding torques refer to unequal holding torques respectively applied to the left and right drive wheels of the automated transport unit to counteract a yaw moment generated by a center-of-gravity offset.

In some embodiments, the asymmetric holding torques may be used to offset a lateral drift angle generated when the transport unit enters the electromagnetic blind window and loses network control.

The lateral drift angle refers to an angle by which an actual travel trajectory of the automated transport unit deviates from an original path due to load eccentricity when the automated transport unit is within the electromagnetic blind window and has lost network control.

In some embodiments, the edge control node may determine the asymmetric holding torques based on the center-of-gravity offset vector through the following Steps 1-4.
Step 1: the edge control node may parse the center-of-gravity offset vector and extract a lateral offset distance component d_{offset} in a direction perpendicular to a traveling direction of the automated transport unit.
Step 2: the edge control node may determine a yaw disturbance moment. According to a rigid-body dynamics model, when the automated transport unit coasts with a deceleration a determined by the feedforward inertial coasting curve, a longitudinal inertial force generated by a total loaded mass m is: Fᵢₙₑᵣₜᵢₐ=m·a. Because the center of gravity is not located on a longitudinal centerline of a vehicle body of the automated transport unit, a moment arm d_{offset} exists between a line of action of the longitudinal inertial force and the centerline, thereby generating a yaw disturbance moment that causes the automated transport unit to rotate about a vertical axis. The yaw disturbance moment is represented by: M_{yaw}=Fᵢₙₑᵣₜᵢₐ·d_{offset}.
Step 3: the edge control node may determine a torque compensation value. A track width L between the left and right drive wheels and a wheel radius r are first obtained from a product specification of the automated transport unit. A wheel driving-force difference required to counteract the yaw disturbance moment is then calculated, and subsequently converted into a torque compensation value. In some embodiments, the wheel driving-force difference may be calculated as: ΔF=M_{yaw}·L, and the torque compensation value may be calculated as: ΔT=ΔF·r.
Step 4: the edge control node may determine the asymmetric holding torques based on a base torque and the torque compensation value. The edge control node obtains a base coasting torque T_{base} through an offline calibration lookup table, and issues: T_{left}=T_{base}+ΔT to the left drive wheel, and T_{right}=T_{base}−ΔT to the right drive wheel. The sign of ΔT depends on an eccentric direction of the center of gravity. For example, when the center of gravity is offset to the left, the sign of ΔT is positive, such that the torque applied to the left drive wheel is greater than the torque applied to the right drive wheel, thereby generating a corrective moment toward the right that exactly offsets a leftward yaw effect caused by the leftward center-of-gravity offset and ensures that the transport unit maintains straight-line coasting.

The offline calibration lookup table includes corresponding relationships among wheel speed, load weight, and base coasting torque.

In some embodiments, the offline calibration lookup table is established by engineers through conducting field tests on coasting characteristics of the automated transport unit under different load levels and different initial vehicle speeds, and recording and compiling motor holding torque values required to enable the transport unit to maintain smooth deceleration.

In some embodiments, when the edge control node determines that the automated transport unit has entered the electromagnetic blind window and lost network control, the edge control node writes the calculated asymmetric holding torques, through a local real-time bus, into target torque registers of drivers corresponding to the left and right drive wheels, respectively, thereby replacing original commands and correcting the lateral drift angle.

In some embodiments of the present disclosure, by applying the asymmetric holding torques during blind-window traversal, trajectory wandering or deviation of the automated transport unit caused by a center-of-gravity offset of the transport unit itself and/or its load during open-loop inertial coasting is effectively addressed. As a result, even when the automated transport unit is within the electromagnetic blind window and has lost network control, the automated transport unit can still maintain its original trajectory while traversing the blind window, thereby avoiding risks of scraping or collision between transported materials or between the automated transport unit itself and a die due to path deviation.

In some embodiments of the present disclosure, by introducing the edge control node into the intelligent manufacturing platform and enabling deep coordination with the production scheduling module and the stamping line, a closed-loop safety system integrating process pre-scheduling, real-time phase perception, interference prediction, and differential autonomous control is established. The beneficial effects thereof include: combining global scheduling capabilities of an upper-level management system with on-site real-time response capabilities of the edge control node; enabling the production line to autonomously execute tasks during temporary communication interruptions through packaged issuance of time-sequenced action sequences and a task buffering mechanism; and, in particular, innovatively partitioning electromagnetic blind windows based on crank phase angles and performing differential degradation control centered on the electromagnetic blind windows, thereby successfully addressing the longstanding problem that “communication interruption leads to immediate shutdown” in a heavy-load stamping environment subject to severe interference. While ensuring absolute safety, production continuity is maintained to the greatest extent possible, thereby achieving simultaneous improvements in robustness and efficiency of the unmanned intelligent manufacturing system operating in harsh industrial environments.

In some embodiments, the first material inventory module is a warehouse, and a material-rack identification device is disposed within the warehouse.

The material-rack identification device (also referred to as an intelligent barcode scanning apparatus for identifying a category of a material box) refers to a sensing and identification device configured to automatically read identifiers of material racks and associated material information, thereby implementing material tracking at a material-rack level and inventory data updating.

In some embodiments of the present disclosure, by configuring the first material inventory module and the second material inventory module as warehouses, raw materials and processed workpieces can be stored.

In some embodiments, the output end of the production scheduling module is electrically connected to a mobile terminal, and the mobile terminal is a smartphone.

In some embodiments of the present disclosure, by providing the mobile terminal, review plans arranged by the production scheduling module can be transmitted to management personnel, thereby preventing delays in handling when management personnel are away from the factory. Personnel at various positions may learn their respective work assignments through the mobile terminal and make preparations in advance.

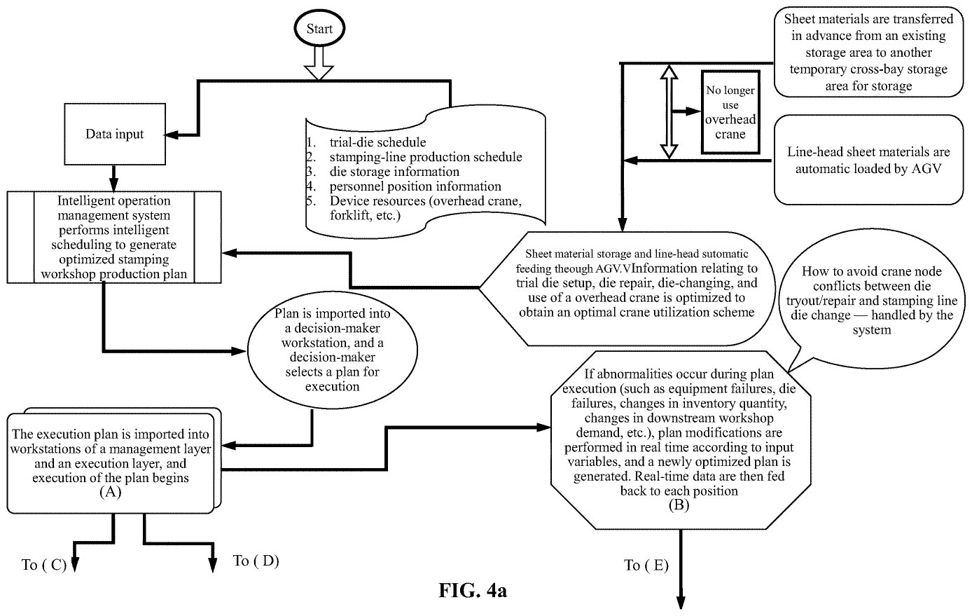

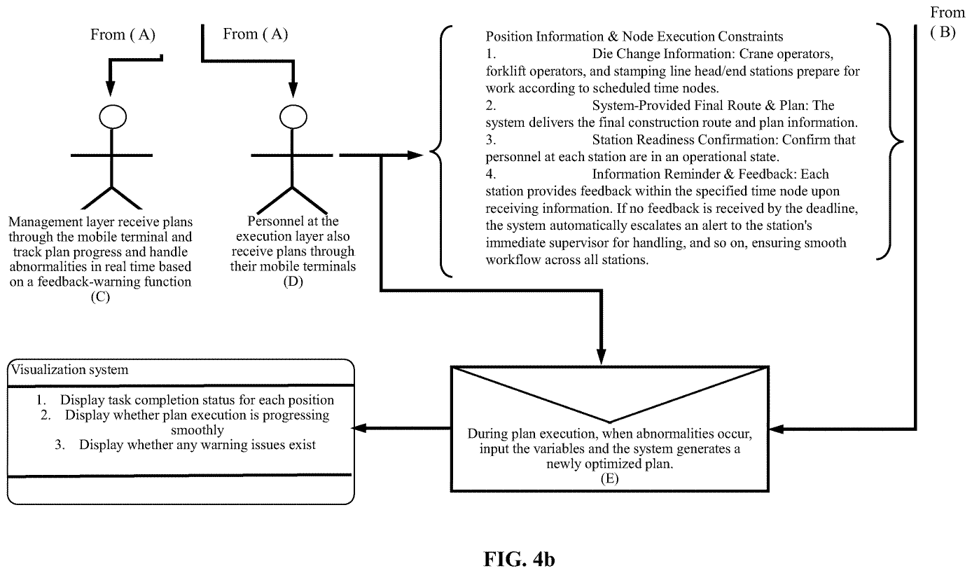

FIGS. 4a and 4b show a workflow system diagram of an intelligent manufacturing platform according to some embodiments of the present disclosure. In some embodiments, with reference to FIGS. 4a and 4b, a visualization system is provided within the device information module, and the visualization system is a high-definition camera.

In some embodiments of the present disclosure, by providing the visualization system, on-site implementation of work at various positions is facilitated, as well as management of on-site operations by supervisors. Visual management display boards may be added in workshops and offices to display, in real time, various construction plans, implementation schemes, completion statuses of preparatory work at different positions, project progress, and whether any warning issues exist.

In some embodiments, as shown in FIGS. 4a and 4b, a workflow of the intelligent manufacturing platform is as follows. Sheet materials are transferred in advance from an existing storage area to another temporary cross-bay storage area for storage. Storage of sheet materials and automatic loading by a line-head AGV are arranged. Information relating to trial die setup, die repair, die-changing, and use of a overhead crane is optimized to obtain an optimal crane utilization scheme. Meanwhile, a trial-die schedule, a stamping-line production schedule, die storage information, and personnel position information are read and subjected to intelligent scheduling, and an optimized stamping workshop production plan is generated via an intelligent operation management system. Next, the plan is imported into a decision-maker workstation, and a decision-maker selects a plan for execution. Thereafter, the execution plan is imported into workstations of a management layer and an execution layer, and execution of the plan begins. During execution of the plan, management is performed according to position information and node execution constraints: first, die replacement information is required to be communicated to positions such as overhead-crane operators, forklift operators, and personnel at line-head and line-end stations of the stamping line, so that preparations can be completed according to scheduled time nodes; second, the system provides final construction-route information and plan information; third, confirmation is made that personnel at each position are in an operational state; fourth, information reminders and feedback are performed. After receiving information, personnel at each position provide feedback according to prescribed time nodes. If no feedback is received before a corresponding time node expires, the system automatically generates a warning and notifies an immediate supervisor of the corresponding position for handling, and so on, thereby ensuring smooth execution of work processes at all positions. Meanwhile, the management layer receives plans through the mobile terminal and track plan progress and handle abnormalities in real time based on a feedback-warning function. Personnel at the execution layer also receive plans through their mobile terminals. The visualization system displays, in real time, whether tasks at each position have been completed, whether plan execution is proceeding smoothly, and whether any warning issues exist. If abnormalities occur during plan execution (such as equipment failures, die failures, changes in inventory quantity, changes in downstream workshop demand, etc.), plan modifications are performed in real time according to input variables, and a newly optimized plan is generated. Real-time data are then fed back to each position, thereby forming a closed-loop workflow for the intelligent manufacturing platform. The intelligent operation management system refers to a subsystem of the intelligent manufacturing platform, used for comprehensive analysis, intelligent scheduling, and optimized dispatching of production tasks, personnel, equipment, dies, and logistics resources. The management layer refers to workshop management personnel, and the execution layer refers to personnel performing production operations on the workshop floor.

In some embodiments, with reference to FIG. 2, the production scheduling module is a computer, and the production order module comprises a keyboard and a mouse.

In some embodiments of the present disclosure, by configuring the production scheduling module as a computer, operating personnel can directly view scheduling information. By configuring the production order module as a keyboard and a mouse, detailed information can be input into the production scheduling module.

In some embodiments, with reference to FIG. 3, the stamping line is a stamping workshop, and the automatic quality inspection module is an unmanned quality inspection device.

The unmanned quality inspection device (also referred to as a product quality detection apparatus) refers to inspection equipment configured to automatically determine whether a workpiece satisfies process standards. For example, the unmanned quality inspection device may comprise an industrial area-scan camera, a laser scanner, or the like.

In some embodiments, by configuring the stamping line as a stamping workshop, devices associated with the stamping line can be prevented from being dispersed at different locations, thereby facilitating management by the operating personnel.

In some embodiments, the intelligent manufacturing platform further comprises a scrap-removal guidance unit, a scrap hopper, and a laser material-level sensor. The laser material-level sensor is configured to acquire an actual accumulated height of scrap within the scrap hopper. The material data module further comprises a scrap-rate calculation unit configured to obtain a theoretical scrap increment generated by a single stamping operation. The production scheduling module is further configured to construct a comparison sequence based on a cumulative value of the theoretical scrap increment generated by each stamping operation and the actual accumulated height acquired after each stamping operation; determine a lap-expansion coefficient based on the comparison sequence through a coefficient prediction model, wherein the coefficient prediction model is a deep learning model; determine an expected time point at which the scrap hopper reaches a full-load state based on the lap-expansion coefficient; monitor a physical coordinate of the scrap-removal guidance unit and determine, based on the physical coordinate, whether the scrap-removal guidance unit is capable of arriving at a slag-discharge position before the expected time point; in response to determining that the scrap-removal guidance unit is capable of arriving at the slag-discharge position before the expected time point, control the scrap-removal guidance unit to perform a scrap-removal and hopper-replacement task; and in response to determining that the scrap-removal guidance unit is incapable of arriving at the slag-discharge position before the expected time point, trigger an energy-preservation mechanism.

For additional details regarding the intelligent manufacturing platform, the scrap-removal guidance unit, the material data module, and the production scheduling module, reference may be made to the corresponding descriptions set forth above.

The scrap hopper refers to a container configured to temporarily store scrap generated by stamping operations performed on the stamping line.

The laser material-level sensor refers to a sensor configured to measure the actual accumulated height of scrap within the scrap hopper. For example, the laser material-level sensor may comprise a multi-point array laser sensor, an array radar sensor, or the like.

In some embodiments, the laser material-level sensor is mounted at a top portion of the scrap hopper and is configured to non-contactingly monitor the actual accumulated height of scrap contained therein.

The actual accumulated height refers to height data acquired by the laser material-level sensor.

In some embodiments, the laser material-level sensor measures the scrap downwardly from the top of the scrap hopper to obtain a three-dimensional point cloud reflecting surface undulations of the scrap. After spatial height data corresponding to respective measurement points on a scrap surface represented in the three-dimensional point cloud are filtered and preprocessed, a plurality of valid height values are averaged to obtain an actual accumulated height value representative of the scrap.

The scrap-rate calculation unit refers to a software calculation module configured to establish a calculus-based mathematical model through analysis of original engineering data.

In some embodiments, the scrap-rate calculation unit is capable of data communication with the production scheduling module.

In some embodiments, the scrap-rate calculation unit is capable of data communication with the uncoiling blanking line and the stamping line.

In some embodiments, the scrap-rate calculation unit is configured to obtain a theoretical scrap amount generated by a single stamping operation.

A stamping operation refers to a process in which a die of the stamping line completes one blank-cutting operation or one forming operation upon closure of the die.

The theoretical scrap increment refers to a theoretical volume value corresponding to metal scrap removed from a blank by the die and deposited into the scrap hopper after a single stamping operation.

In some embodiments, the scrap-rate calculation unit may invoke an analysis library to open a stamping nesting model corresponding to a current production batch in the ERP platform. The scrap-rate calculation unit then applies a closed-curve area algorithm to identify and extract all closed regions enclosed by boundaries of “scrap blanking holes” and “edge scrap” marked as non-finished-product portions in the stamping nesting model, and accumulates areas of the closed regions to obtain a total two-dimensional area. The scrap-rate calculation unit reads a sheet-thickness parameter specified by the bill of materials in the ERP platform and multiplies the total two-dimensional area by the sheet-thickness parameter to calculate a theoretical scrap increment generated by a single stamping operation under an assumption that a material is in a 100% dense state, the theoretical scrap increment being expressed as a volume value.

The stamping nesting model refers to a two-dimensional engineering drawing used in a stamping process design stage to define blanking positions of parts on a sheet material, arrangement modes, and distribution of scrap regions. For example, the stamping nesting model may be a computer-aided design (CAD) drawing.

The comparison sequence refers to a sequence formed by arranging, in chronological order, a difference between a theoretical accumulated height corresponding to the cumulative value of theoretical scrap increments and the actual accumulated height measured by the laser material-level sensor after each stamping operation. By way of example, the comparison sequence may be expressed as: [ΔH₁, ΔH₂, ΔH₃, . . . , ΔHₜ].

In some embodiments, the theoretical accumulated height corresponding to the cumulative value of theoretical scrap increments may be obtained by dividing the cumulative value of theoretical scrap increments by a bottom area of the scrap hopper. The bottom area of the scrap hopper may be obtained by referring to a product specification of the scrap hopper.

In some embodiments, after each stamping operation is completed, the production scheduling module acquires, from the scrap-rate calculation unit, the cumulative value of theoretical scrap increments up to the end of the current stamping operation, divides the cumulative value by the bottom area of the scrap hopper obtained from the product specification, and obtains a current theoretical accumulated height. Subsequently, the production scheduling module synchronously acquires an actual accumulated height calculated by the laser material-level sensor after the same stamping operation, calculates a difference between the theoretical accumulated height and the actual accumulated height, and obtains a height difference corresponding to the stamping operation. The height differences are arranged in sequence according to the chronological order of stamping operations to form the comparison sequence.

The lap-expansion coefficient refers to a ratio between an apparent fluffy volume formed due to random stacking support of irregular scrap after falling into the scrap hopper and the cumulative value of theoretical scrap increments.

The coefficient prediction model refers to a model configured to predict the lap-expansion coefficient. In some embodiments, the coefficient prediction model is a deep learning model. For example, the coefficient prediction model may be one or a combination of a long short-term memory (LSTM) network model, a temporal convolutional network (TCN) model, or other customized models.

In some embodiments, an input of the coefficient prediction model is the comparison sequence, and an output of the coefficient prediction model is the lap-expansion coefficient.

In some embodiments, the coefficient prediction model may be obtained by training an initial coefficient prediction model using a plurality of second training samples each having a second label. Each second training sample may include a comparison time-series sequence fully recorded before each scrap-removal operation during a historical production cycle, and the second label may include the lap-expansion coefficient of the second training sample under the full-load state, which may be manually annotated.

In some embodiments, the second training samples and the second labels may be obtained based on historical scrap-removal cycle records.

The training process of the coefficient prediction model is similar to the training process of the parameter prediction model, and for details of the training process, reference may be made to the corresponding description set forth above.

In some embodiments, the input of the coefficient prediction model further includes a scrap morphology factor.

The scrap morphology factor refers to a feature parameter configured to quantify geometric characteristics of scrap, including shape, size distribution, and degree of curling.

In some embodiments, the scrap morphology factor may be determined through the following steps:
S1, extracting a boundary equation: the scrap-rate calculation unit extracts a two-dimensional closed boundary contour of a single scrap piece from the stamping nesting model, discretizes the contour into a parametric curve C(s) composed of a plurality of vertices, and calculates a total perimeter thereof. The parameterized curve C(s) is composed of two coordinate functions that vary with s: x(s) and y(s). When traversing a distance s along a two-dimensional closed edge contour, the horizontal coordinate of that point is x(s) and the vertical coordinate is y(s).
S2, calculating corner-point density: inner angles at respective vertices along the parametric curve are traversed, and an acute-angle threshold (e.g., 60 degrees) is set. A total number of sharp corners having inner angles smaller than the acute-angle threshold is counted, and a sharp-corner total is divided by the total perimeter to obtain a corner-point density θ.
S3, calculating an average edge curvature: an absolute curvature is calculated point-by-point along the parametric curve, and the following curvature Equation (2) is used to integrate the entire curve, after which an average edge curvature is obtained using Equation (3):

$$k ( s ) = \frac{\vert {x}^{′} ( s ) \cdot {y}^{″} ( s ) - {y}^{′} ( s ) \cdot {x}^{″} ( s ) \vert}{{( {{x}^{′} ( s )}^{2} + {{y}^{′} ( s )}^{2} )}^{3 / 2}} , \qquad ( 2 )$$

wherein, s represents an arc length parameter, k(s) represents curvature; x(s) and y(s) are coordinates of respective points on the parametric curve; x′(s) and y′(s) are first-order derivatives of x(s) and y(s); and x″(s) and y″(s) are second-order derivatives of x(s) and y(s).

$${K}_{avg} = \frac{1}{P} {\int }_{0}^{P} \vert k ( s ) \vert ds , \qquad ( 3 )$$

wherein, P represents the total perimeter of the parametric curve; k(s) represents curvature, as obtained from Equation (2); and K_{avg} represents the average edge curvature.
S4, calculating the scrap morphology factor: the corner-point density and the average edge curvature are weighted and summed to obtain the scrap morphology factor, as shown in Equation (4):

Ctopo=ω₁·θ+ω₂·K_{avg} (4),

wherein, Ctopo represents the scrap morphology factor, and ω₁ and ω₂ are weighting coefficients, which may be calibrated based on a material thickness of the scrap.

In some embodiments of the present disclosure, after introducing the scrap morphology factor, the coefficient prediction model is enabled to distinguish the influence of different types of scrap (e.g., slender strips, large sheet-like scraps, and curled filament-like scraps) on a stacking void ratio, such that prediction of the lap-expansion coefficient is more consistent with actual production line conditions, thereby reducing overflow of the scrap hopper or premature or late scrap-removal operations due to misjudgment, and improving robustness of scrap-removal and hopper-replacement tasks.

The full-load state refers to a state in which the actual accumulated height within the scrap hopper reaches or exceeds a preset maximum warning height.

In some embodiments, after the scrap hopper reaches the full-load state, continued stamping may cause scrap overflow, blockage of a scrap channel, or damage to stamping equipment.

The expected time point refers to a specific moment at which the scrap hopper is predicted to reach the full-load state.

In some embodiments, the production scheduling module may determine the expected time point at which the scrap hopper reaches the full-load state based on a stroke frequency of a main spindle, the lap-expansion coefficient, and the maximum warning height.

By way of example, the production scheduling module extracts a safe full-load volume Vₘₐₓ of the scrap hopper, and subtracts an actual occupied volume V_{current} measured by the laser material-level sensor to obtain a remaining available volume Vᵣₑₘₐᵢₙ within the scrap hopper. The production scheduling module then acquires a theoretical scrap increment V_{solid} generated by a single stamping operation from the scrap-rate calculation unit, and multiplies the theoretical scrap increment by the stroke frequency f (in strokes per minute) of the main spindle of the stamping press to calculate a theoretical volumetric generation rate per unit time. The theoretical volumetric generation rate is then multiplied by the lap-expansion coefficient α predicted by the coefficient prediction model to obtain an actual apparent volumetric generation rate Rₐₚₚₐᵣₑₙₜ representing a fluffy stacking state of scrap, where Rₐₚₚₐᵣₑₙₜ=v_{solid}·f·a. Finally, the remaining available volume Vᵣₑₘₐᵢₙ is divided by the actual apparent volumetric generation rate Rₐₚₚₐᵣₑₙₜ to calculate a remaining safe operating duration Δt before physical full-load of the scrap hopper. A current system time T_{now} is then added to the safe operating duration Δt to determine the expected time point T_{target} at which the scrap hopper reaches the full-load state.

The physical coordinate refers to a real-time position coordinate of the scrap-removal guidance unit within a workshop. In some embodiments, the production scheduling module may monitor the physical coordinate based on a positioning device installed on the scrap-removal guidance unit. The positioning device may comprise an ultra-wideband (UWB) positioning device, a visual odometry device, or the like.

The slag-discharge position refers to a designated position above the scrap hopper for scrap-removal and hopper-replacement operations.

It is understood that the scrap-removal guidance unit reaching the slag-discharge position may include two cases: the scrap-removal guidance unit is incapable of arriving at the slag-discharge position before the expected time point, and the scrap-removal guidance unit is capable of arriving at the slag-discharge position before the expected time point.

In some embodiments, the production scheduling module may calculate an actual arrival time based on the physical coordinate of the scrap-removal guidance unit, a preset navigation path, and a traveling speed. By way of example, the production scheduling module may calculate the actual arrival time using Equation (5), as shown below:

t_{actual}=l/v (5),

wherein, t_{actual} represents the actual arrival time; l represents the preset navigation path, which may be manually preset; and v represents the traveling speed of the scrap-removal guidance unit. In some embodiments, the production scheduling module may measure a linear speed of the scrap-removal guidance unit through an encoder of a drive wheel motor of the scrap-removal guidance unit, and use the measured value as the traveling speed.

In some embodiments, when the actual arrival time is equal to or later than the expected arrival time, the production scheduling module determines that the scrap-removal guidance unit is incapable of arriving at the slag-discharge position before the expected time point; and when the actual arrival time is earlier than the expected arrival time, the production scheduling module determines that the scrap-removal guidance unit is capable of arriving at the slag-discharge position before the expected time point.

The scrap-removal and hopper-replacement task refers to an operation in which the scrap-removal guidance unit moves to the slag-discharge position, removes a full-load scrap hopper, and replaces it with an empty scrap hopper.

In some embodiments, the production scheduling module controls the scrap-removal guidance unit to carry an empty scrap hopper to a target slag-discharge position; removes the full-load scrap hopper via a lifting or traction mechanism and loads the full-load scrap hopper onto the scrap-removal guidance unit; then releases the empty scrap hopper and locks it at the slag-discharge position; and finally transports the replaced full-load scrap hopper to a scrap treatment area, thereby completing the scrap-removal and hopper-replacement task.

The energy-preservation mechanism refers to an emergency protection strategy automatically triggered when it is determined that the scrap-removal guidance unit is unable to arrive at the slag-discharge position before the scrap hopper reaches the full-load state, and is configured to slow down a scrap accumulation rate or extend a full-load time so as to prevent scrap overflow. For example, the energy-preservation mechanism may include reducing the stamping frequency, temporarily stopping the stamping press, or requesting manual intervention.

In some embodiments, the production scheduling module is further configured to calculate a delay time difference associated with arrival of the scrap-removal guidance unit at the slag-discharge position and an effective volumetric capacity of the scrap hopper; generate a smooth frequency-reduction curve based on the delay time difference and the effective volumetric capacity; and control, via a variable-frequency drive, the main motor of the stamping line to reduce the stroke frequency according to the smooth frequency-reduction curve.

The delay time difference refers to a time difference by which the actual arrival time of the scrap-removal guidance unit is later than the expected time point.

In some embodiments, the delay time difference may be a difference between the actual arrival time and the expected time point.

The effective volumetric capacity refers to an available volumetric difference between the maximum warning height of the scrap hopper and a current actual accumulated height.

In some embodiments, the three-dimensional point cloud of the interior of the scrap hopper acquired by the laser material-level sensor is processed to output the current actual accumulated height H_{current}. The production scheduling module may determine the effective volumetric capacity based on the maximum warning height Hₘₐₓ of the scrap hopper and a geometric model (e.g., a cross-sectional area function) of the scrap hopper. By way of example, the production scheduling module may calculate the effective volumetric capacity V_{effective} using Equation (6), as shown below:

$${V}_{effective} = {\int }_{{H}_{current}}^{{H}_{max}} A ( h ) dh , \qquad ( 6 )$$

wherein, V_{effective} represents the effective volumetric capacity; Hₘₐₓ represents the maximum warning height; A(h) represents the cross-sectional area function of the scrap hopper, with the independent variable being a vertical height h; h is an integration variable, representing any vertical height within the scrap hopper measured upward from the bottom of the scrap hopper, with its range of values being [H_{current}, Hₘₐₓ].

The smooth frequency-reduction curve refers to a control command data curve issued to the main motor for gradually reducing the stroke frequency according to a specific frequency regulation strategy, for delaying a time at which a scrap hopper reaches a full-load state, under a premise that stamping power is not interrupted and a clutch is not disengaged.

In some embodiments, the horizontal axis of the smooth frequency-reduction curve represents time, and the vertical axis represents stroke frequency.

In some embodiments, the production scheduling module first invokes the lap-expansion coefficient currently output by the coefficient prediction model, and combines the theoretical scrap increment of a single stamping operation to convert the remaining effective volumetric capacity into a maximum allowable number of remaining stamping operations before complete overflow. Subsequently, the production scheduling module distributes the maximum allowable number of remaining stamping operations evenly over an entire waiting time interval from a current moment to the expected time point at which the scrap-removal guidance unit arrives at the slag-discharge position, and derives target values of real-time stroke frequency that satisfies a “no premature overflow” constraint at any moment within the waiting time interval. The production scheduling module further fits the target values along a time axis (i.e., the horizontal axis) into a continuous decreasing rotational speed instruction sequence, thereby obtaining the smooth frequency-reduction curve.

The variable-frequency drive refers to a power electronic device installed in a power supply circuit of the main motor of the stamping line and configured to adjust a rotational speed of the main motor by varying an output power frequency.

The main motor is a drive motor for a flywheel or crank mechanism of the stamping line. In some embodiments, after receiving an instruction of the smooth frequency-reduction curve, the variable-frequency drive reduces an output frequency in a time-segmented manner, such that the rotational speed of the motor decreases synchronously and a strokes-per-minute rate of stamping operations is correspondingly reduced, thereby reducing a scrap generation amount per unit time.

In some embodiments of the present disclosure, compared with sudden shutdown or fixed low-speed operation, the smooth frequency-reduction curve generated based on the delay time difference and the effective volumetric capacity prevents scrap overflow of the scrap hopper while maximizing production continuity. Meanwhile, impact loads on a motor and a mechanical transmission system caused by abrupt deceleration are reduced, thereby extending a service life of equipment and implementing flexible self-protection in a scenario where scrap removal is not timely.

In some embodiments of the present disclosure, the system addresses a technical problem in an unmanned stamping scenario in which scrap overflow from the scrap hopper may damage a die. By sequentially comparing the theoretical scrap increment obtained by the scrap-rate calculation unit with the actual accumulated height measured by the laser material-level sensor, and predicting the lap-expansion coefficient using the coefficient prediction model, high-precision active prediction of a full-load time point of the scrap hopper is achieved. On this basis, when the physical coordinate of the scrap-removal guidance unit is monitored and determined to indicate a delayed arrival, rather than simply stopping the production line and waiting, the energy-preservation mechanism is triggered. The stroke frequency is gradually reduced via the smooth frequency-reduction curve without disconnecting the clutch or cutting off power to the main motor, thereby trading cycle time for response time, fundamentally preventing scrap overflow and die damage, while preserving rotational kinetic energy of a large stamping flywheel and avoiding significant power consumption, prolonged downtime, and equipment wear caused by flywheel shutdown and restart, thereby achieving coordinated die safety, energy efficiency, and continuous production requirements in a fully unmanned manufacturing environment.

In some embodiments, a working principle and a usage flow of the intelligent manufacturing platform are as follows. During use, an operator first transmits data into an internal portion of the production scheduling module through the automatic scheduling module. The production scheduling module analyzes the data and generates a scheduling plan to form planned orders. Subsequently, warehouse inventory data is transmitted from the warehouse data module and the second material inventory module into the first material inventory module. Thereafter, collected data of a bill of materials is transmitted into the BOM module. Then, order data is transmitted from the production order module into the material data module. The material data module drives the uncoiling blanking line and the stamping line based on the order data, and the uncoiling blanking line and the stamping line process raw materials transmitted from the first material inventory module and the BOM module to form shaped products. The shaped products are then inspected by the automatic quality inspection module, packaged by the automatic packaging module, and subsequently stored in the automated storage and retrieval module, thereby achieving an effect of automated manufacturing.

In some embodiments of the present disclosure, the unmanned intelligent manufacturing system is provided. By configuring the ERP system, market sales data is collected and transmitted into the unmanned intelligent manufacturing system of a stamping factory. The intelligent manufacturing platform controls the unmanned stamping platform to adjust production decisions of a workshop, including prioritizing production or prioritizing new vehicle models, and reasonably allocating auxiliary resources of the workshop according to priority levels, thereby achieving an effect of automated manufacturing and solving a problem of inability to perform automated manufacturing.

It should be noted that, in the present disclosure, relational terms such as “first” and “second” are used merely to distinguish one entity or operation from another entity or operation, and do not necessarily require or imply any such actual relationship or order between the entities or operations. Moreover, terms such as “comprise,” “include,” or any other variations thereof are intended to cover a non-exclusive inclusion, such that a process, method, article, or apparatus that includes a list of elements not only includes those elements, but also may include other elements not explicitly listed or inherent to such process, method, article, or apparatus.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

Meanwhile, the present disclosure uses specific terms to describe the embodiments herein. Terms such as “one embodiment,” “an embodiment,” and/or “some embodiments” mean that a certain feature, structure, or characteristic related to at least one embodiment of the present disclosure. Therefore, it is emphasized and noted that the terms “an embodiment,” “one embodiment,” or “an alternative embodiment” mentioned two or more times at different locations in the present disclosure do not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers or letters, or the use of other names in the present disclosure is not intended to limit the order of the processes and methods described herein. Although the foregoing disclosure discusses some currently considered useful inventive embodiments through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the system components described above may be implemented via hardware devices, they may also be realized solely through software solutions, such as installing the described system on existing servers or mobile devices.

Similarly, it should be noted that to simplify the presentation of the present disclosure and thereby aid in understanding one or more inventive embodiments, in the descriptions of the embodiments of the present disclosure above, various features may sometimes be grouped into a single embodiment, figure, or description thereof. However, this disclosure manner does not imply that the subject matter of the present disclosure requires more features than those mentioned in the claims. In fact, the features of an embodiment are fewer than all the features of a single embodiment disclosed above.

In some embodiments, numbers describing quantities or attributes are used. It should be understood that such numbers used in the description of the embodiments may, in some examples, be modified by the terms “approximately,” “about,” or “substantially.” Unless otherwise specified, “approximately,” “about,” or “substantially” indicates that the stated number allows for a variation of +20%. Accordingly, in some embodiments, the numerical parameters used in the specification and claims are approximations, which may vary depending on the characteristics required by individual embodiments. In some embodiments, numerical parameters should consider the specified number of significant digits and adopt the method of general digit retention. Although the numerical ranges and parameters used to confirm their breadth in some embodiments of the present disclosure are approximations, in specific embodiments, such numerical values are set as accurately as possible within the feasible range.

For each patent, patent application, patent application publication, and other material, such as articles, books, specifications, publications, documents, etc., cited in the present disclosure, the entire content thereof is hereby incorporated by reference into the present disclosure. Excluded are application history documents that are inconsistent or conflict with the content of the present disclosure, and documents that limit the broadest scope of the claims of the present disclosure (whether currently or subsequently appended to the present disclosure). It should be noted that if the description, definition, and/or use of terms in the supplementary materials of the present disclosure are inconsistent or conflict with those in the present disclosure, the description, definition, and/or use of terms in the present disclosure shall prevail.

Finally, it should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. An unmanned intelligent manufacturing system, comprising: an intelligent manufacturing platform, an enterprise resource planning (ERP) platform, and an unmanned stamping platform, wherein
an input end of the intelligent manufacturing platform is electrically connected to the ERP platform, and an output end of the intelligent manufacturing platform is electrically connected to the unmanned stamping platform, the intelligent manufacturing platform comprises a material data module, a first material inventory module, a bill-of-materials (BOM) module, a production scheduling module, and a device information module;
the ERP platform comprises a production order module, a warehouse data module, a second material inventory module, a bill of materials, and an automatic scheduling module, wherein an output end of the production order module is electrically connected to an input end of the material data module, an output end of the warehouse data module is electrically connected to an input end of the first material inventory module, an output end of the second material inventory module is electrically connected to the input end of the first material inventory module, an output end of the bill of materials is electrically connected to an input end of the BOM module, and an output end of the automatic scheduling module is electrically connected to an input end of the production scheduling module;
the unmanned stamping platform comprises an uncoiling blanking line, a stamping line, an automatic quality inspection module, an automatic packaging module, an automated storage and retrieval module, and an automated guided vehicle (AGV) module, wherein an output end of the device information module is electrically connected to an input end of the uncoiling blanking line, the output end of the device information module is electrically connected to an input end of the stamping line, the output end of the device information module is electrically connected to an input end of the automatic quality inspection module, the output end of the device information module is electrically connected to an input end of the automatic packaging module, the output end of the device information module is electrically connected to an input end of the automated storage and retrieval module, the output end of the device information module is electrically connected to an input end of the AGV module, an output end of the production scheduling module is electrically connected to the input end of the uncoiling blanking line, the output end of the production scheduling module is electrically connected to the input end of the stamping line, an output end of the material data module is electrically connected to the input end of the uncoiling blanking line, the output end of the material data module is electrically connected to the input end of the stamping line, an output end of the BOM module is electrically connected to the input end of the uncoiling blanking line, and the output end of the BOM module is electrically connected to the input end of the stamping line;
wherein the intelligent manufacturing platform further comprises an eccentricity detection array configured to:
acquire a weight distribution matrix of stacked blanks; and
determine a center-of-gravity offset vector of the stacked blanks based on the weight distribution matrix;
wherein the production scheduling module is configured to:
generate motion control parameters based on the center-of-gravity offset vector and transmit the motion control parameters to the AGV module, the motion control parameters comprising a centripetal-force threshold curve and acceleration step limits; and
wherein the AGV module is configured to:
under a turning condition, determine a target centripetal-force threshold from the centripetal-force threshold curve based on current operating parameters of an automated transport unit, and limit an angular velocity of a steering motor of the automated transport unit based on the target centripetal-force threshold; and
under a braking condition, reduce output torque of drive wheels of the automated transport unit in stages based on the acceleration step limits or increase braking force applied to the drive wheels in stages.

2. The unmanned intelligent manufacturing system according to claim 1, wherein the production scheduling module is further configured to:
acquire, through a contour scanning device, an outer contour cross-section corresponding to the stacked blanks after each blanking operation;
sequentially extract a boundary deviation between each two adjacent outer contour cross-sections to obtain a set of boundary deviations;
determine a cumulative slip vector based on the set of boundary deviations;
generate a spatial envelope based on an initial outer contour cross-section and the cumulative slip vector; and
determine a volumetric centroid of the spatial envelope and designate the volumetric centroid as a geometric center.

3. The unmanned intelligent manufacturing system according to claim 1, wherein a management module and an execution module are further provided in the intelligent manufacturing platform, wherein
the management module comprises a production management unit, a device management unit, a quality management unit, a material management unit, a production line management unit, a personnel management unit, a master control display unit, and a sub-control display unit; and
the execution module comprises a line-head automatic loading unit, a schedule progress management unit, the automated transport unit, an product automatic quality inspection unit, a line-end automatic packaging unit, an inventory material management unit, an end effector replacement unit, and a die change unit.

4. The unmanned intelligent manufacturing system according to claim 3, wherein the automated transport unit is an intelligent unmanned forklift or a trackless intelligent automated guided cart, and a transport weight of the automated transport unit is less than five tons.

5. The unmanned intelligent manufacturing system according to claim 3, wherein the intelligent manufacturing platform further comprises an edge control node, the edge control node being communicatively connected to the production scheduling module and the management module;
the production scheduling module is configured to:
package action instructions comprising a plurality of consecutive process-operation nodes into a time-sequenced action sequence and transmit the time-sequenced action sequence to a task buffer pool of the edge control node;
the edge control node is configured to:
acquire crank phase-angle data of a main transmission mechanism of the stamping line;
define an electromagnetic blind window based on the crank phase-angle data and a heavy-load stamping sequence;
transmit monitoring packets to the production scheduling module and the management module at a preset frequency, and trigger a stamping disconnection event when a number of consecutively lost packets exceeds a packet-loss threshold; and
in response to triggering the stamping disconnection event, execute differentiated degradation control.

6. The unmanned intelligent manufacturing system according to claim 5, wherein the edge control node is further configured to:
in response to determining that the stamping disconnection event occurs within the electromagnetic blind window, intercept an emergency braking signal of the automated transport unit, and determine a feedforward inertial coasting curve based on wheel-speed data at a moment immediately preceding occurrence of the stamping disconnection event;
control, based on the feedforward inertial coasting curve, the automated transport unit to maintain an original trajectory and traverse the electromagnetic blind window, and re-establish communication after exiting the electromagnetic blind window;
in response to determining that the stamping disconnection event occurs outside the electromagnetic blind window, determine that the stamping disconnection event is a genuine communication-link failure;
in response to determining that the stamping disconnection event is the genuine communication-link failure, terminate execution of a current task, and control a robotic arm to skip the action instructions in the task buffer pool that have not yet been executed;
control the robotic arm, based on an avoidance trajectory, to retreat along the avoidance trajectory to a die safety zone; and
execute servo braking after the robotic arm enters the die safety zone.

7. The unmanned intelligent manufacturing system according to claim 5, wherein the edge control node is further configured to:
determine asymmetric holding torques based on the center-of-gravity offset vector; and
when the automated transport unit enters the electromagnetic blind window and loses network control, issue the asymmetric holding torques to left and right drive wheels of the automated transport unit.

8. The unmanned intelligent manufacturing system according to claim 5, wherein the edge control node is further configured to:
adjust the electromagnetic blind window based on the crank phase-angle data, the heavy-load stamping sequence, and a smooth frequency-reduction curve.

9. The unmanned intelligent manufacturing system according to claim 1, wherein the first material inventory module is a warehouse, and a material-rack identification device is disposed within the warehouse.

10. The unmanned intelligent manufacturing system according to claim 1, wherein the output end of the production scheduling module is electrically connected to a mobile terminal, and the mobile terminal is a smartphone.

11. The unmanned intelligent manufacturing system according to claim 1, wherein a visualization system is disposed within the device information module, and the visualization system is a high-definition camera.

12. The unmanned intelligent manufacturing system according to claim 1, wherein the production scheduling module is a computer, and the production order module is a keyboard and a mouse.

13. The unmanned intelligent manufacturing system according to claim 1, wherein the stamping line is a stamping workshop, and the automatic quality inspection module is an unmanned quality inspection device.

14. The unmanned intelligent manufacturing system according to claim 1, wherein the intelligent manufacturing platform further comprises a scrap-removal guidance unit, a scrap hopper, and a laser material-level sensor;
the laser material-level sensor is configured to acquire an actual accumulated height of scrap within the scrap hopper;
the material data module further comprises a scrap-rate calculation unit, the scrap-rate calculation unit being configured to obtain a theoretical scrap increment generated by a single stamping operation;
the production scheduling module is further configured to:
construct a comparison sequence based on a cumulative value of the theoretical scrap increment generated by each stamping operation and the actual accumulated height acquired after each stamping operation;
determine a lap-expansion coefficient based on the comparison sequence through a coefficient prediction model, wherein the coefficient prediction model is a deep learning model;
determine an expected time point at which the scrap hopper reaches a full-load state based on the lap-expansion coefficient;
monitor a physical coordinate of the scrap-removal guidance unit and determine, based on the physical coordinate, whether the scrap-removal guidance unit is capable of arriving at a slag-discharge position before the expected time point;
in response to determining that the scrap-removal guidance unit is capable of arriving at the slag-discharge position before the expected time point, control the scrap-removal guidance unit to perform a scrap-removal and hopper-replacement task; and
in response to determining that the scrap-removal guidance unit is incapable of arriving at the slag-discharge position before the expected time point, trigger an energy-preservation mechanism.

15. The unmanned intelligent manufacturing system according to claim 14, wherein the production scheduling module is further configured to:
calculate a delay time difference associated with arrival of the scrap-removal guidance unit at the slag-discharge position and an effective volumetric capacity of the scrap hopper;
generate a smooth frequency-reduction curve based on the delay time difference and the effective volumetric capacity; and
control, through a variable-frequency drive, a main motor of the stamping line to reduce a stroke frequency according to the smooth frequency-reduction curve.

16. The unmanned intelligent manufacturing system according to claim 14, wherein an input of the coefficient prediction model comprises a scrap morphology factor.
